(19) United States
(12) Patent Application Publication
(10) Pub. No.: US 2014/0304007 A1
(43) Pub. Date: Oct. 9, 2014

(54) SYSTEMS AND METHODS FOR ACCOUNT-LEVEL FLOOD RISK ASSESSMENT

(71) Applicant: THE TRAVELERS INDEMNITY COMPANY, Hartford, CT (US)

(72) Inventors: Michael Kimball, East Hartford, CT (US); James B. Coyle, Farmington, CT (US); Jonathan P. Stein, West Hartford, CT (US)

(73) Assignee: The Travelers Indemnity Company, Hartford, CT (US)

(21) Appl. No.: 13/857,981

(22) Filed: Apr. 5, 2013

(51) Int. Cl. G06Q 40/08; G06Q 10/06

(52) U.S. Cl. CPC G06Q 40/08; G06Q 10/0635
USPC 705/4

(57) ABSTRACT

Systems, apparatus, interfaces, methods, and articles of manufacture that provide for account-level flood risk assessment.

### BACKGROUND

Flood risk is a common variable that is considered in determining whether or not, or to what extent, to offer insurance to a potential customer. Flood zones designated by the Federal Emergency Management Agency (FEMA), for example, are often utilized to determine whether an insurance company has the risk appetite to underwrite a particular policy. Structuring insurance decisions on FEMA flood zones, however, may often lead to over or under exposure, either of which may result in lost profits.

### BRIEF DESCRIPTION OF THE DRAWINGS

An understanding of embodiments described herein and many of the attendant advantages thereof may be readily obtained by reference to the following detailed description when considered with the accompanying drawings, wherein:

FIG. 1 is a block diagram of a system according to some embodiments;

FIG. 2 is a flow diagram of a method according to some embodiments;

FIG. 3 is a perspective view of an example location according to some embodiments;

FIG. 4A, FIG. 4B, FIG. 4C, and FIG. 4D are diagrams of an example data storage structure according to some embodiments;

FIG. 5 is a flow diagram of a method according to some embodiments;

FIG. 6 is a flow diagram of a method according to some embodiments;

FIG. 7 is a flow diagram of a method according to some embodiments;

FIG. 8 is a diagram of an exemplary risk matrix according to some embodiments;

FIG. 9A and FIG. 9B are diagrams of example interfaces according to some embodiments;

FIG. 10 is a block diagram of an apparatus according to some embodiments; and

FIG. 11A, FIG. 11B, FIG. 11C, and FIG. 11D are perspective diagrams of exemplary data storage devices according to some embodiments.

### DETAILED DESCRIPTION

Embodiments described herein are descriptive of systems, apparatus, methods, interfaces, and articles of manufacture for account-level flood risk assessment. In some embodiments, for example, flood risk attributes for multiple buildings (and/or other structures) associated with an account may be analyzed to determine an account-level flood risk score (e.g., an Account Flood Risk Score (AFRS)). Such an AFRS may, for example, be utilized to scale a risk of an object relative to one or more other objects (e.g., to compare risks between a plurality of objects).

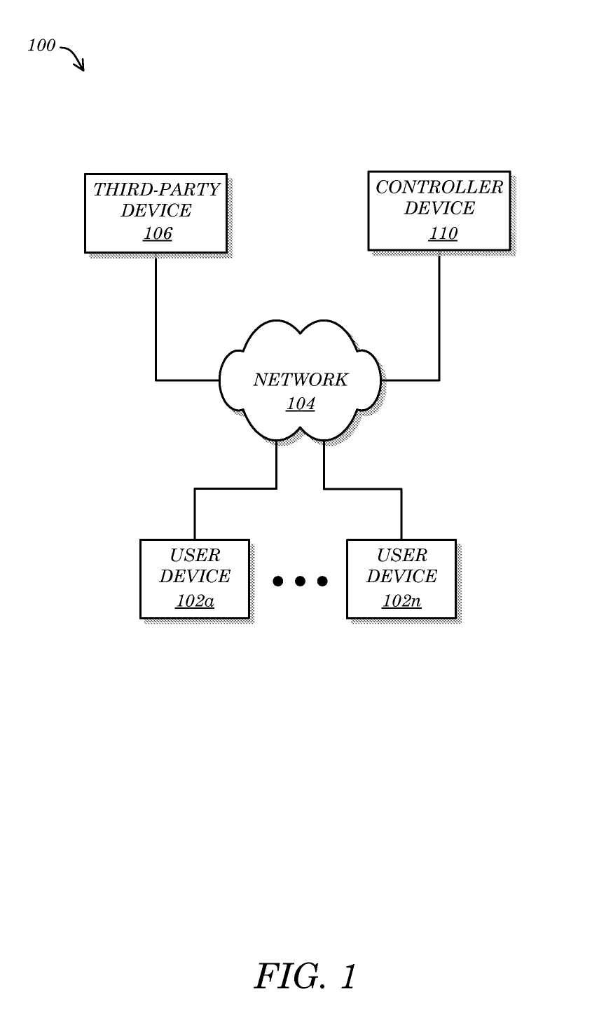

Referring first to FIG. 1, a block diagram of a system 100 according to some embodiments is shown. In some embodiments, the system 100 may comprise a plurality of user devices 102a-n, a network 104, a third-party device 106, and/or a controller device 110. As depicted in FIG. 1, any or all of the devices 102a-n, 106, 110 (or any combinations thereof) may be in communication via the network 104. In some embodiments, the system 100 may be utilized to provide (and/or receive) flood risk, building (and/or structure), and/or other data or metrics. The controller device 110 may, for example, interface with one or more of the user devices 102a-n and/or the third-party device 106 to acquire, gather, aggregate, process, and/or utilize flood risk, building (and/or structure), and/or other data or metrics in accordance with embodiments described herein.

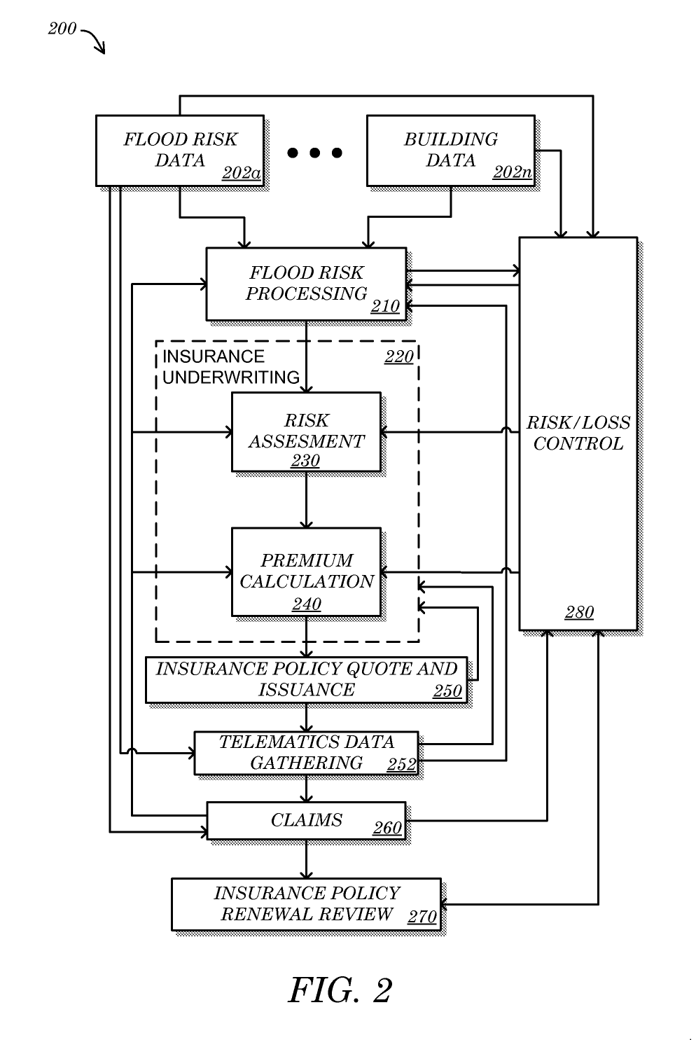

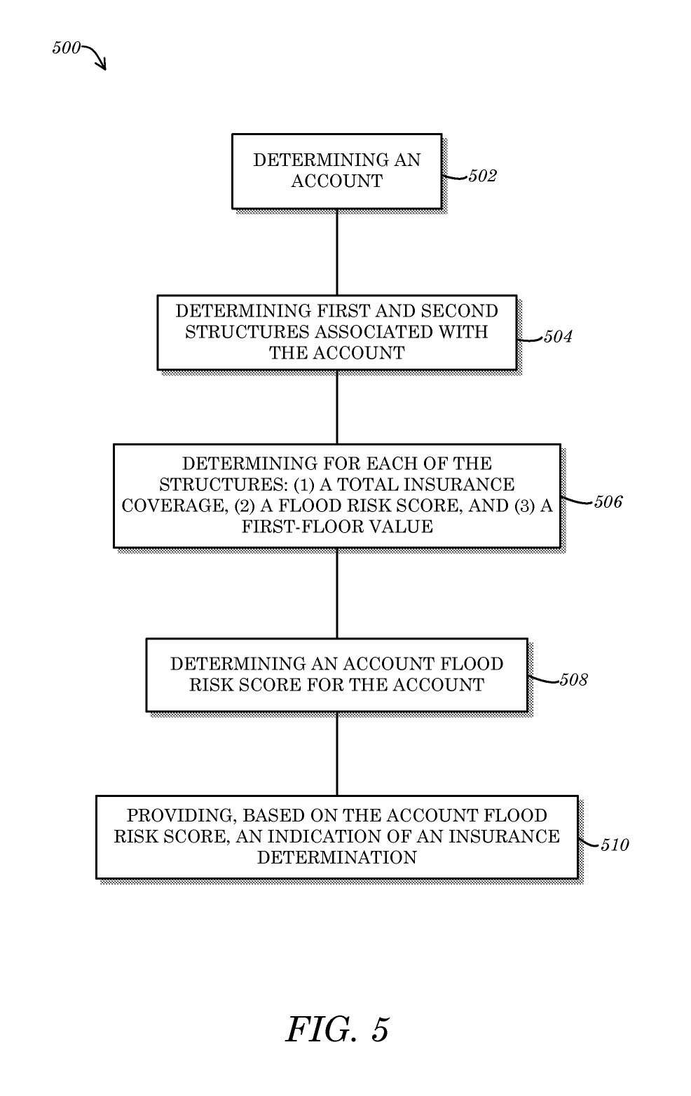

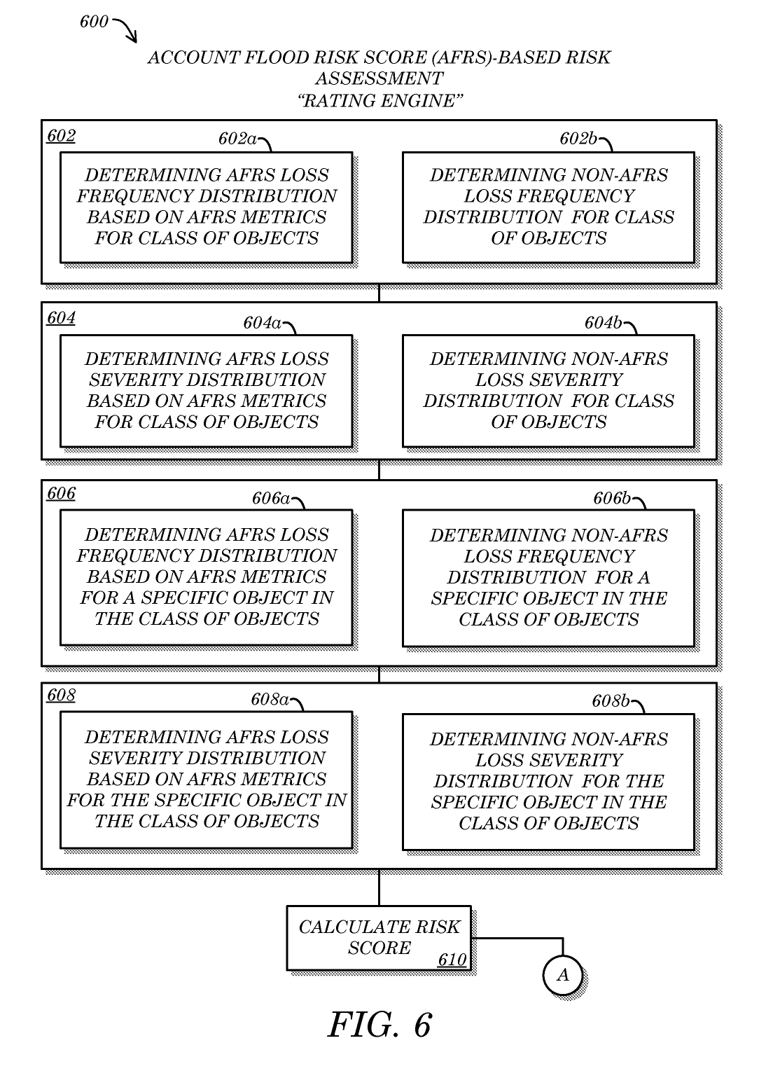

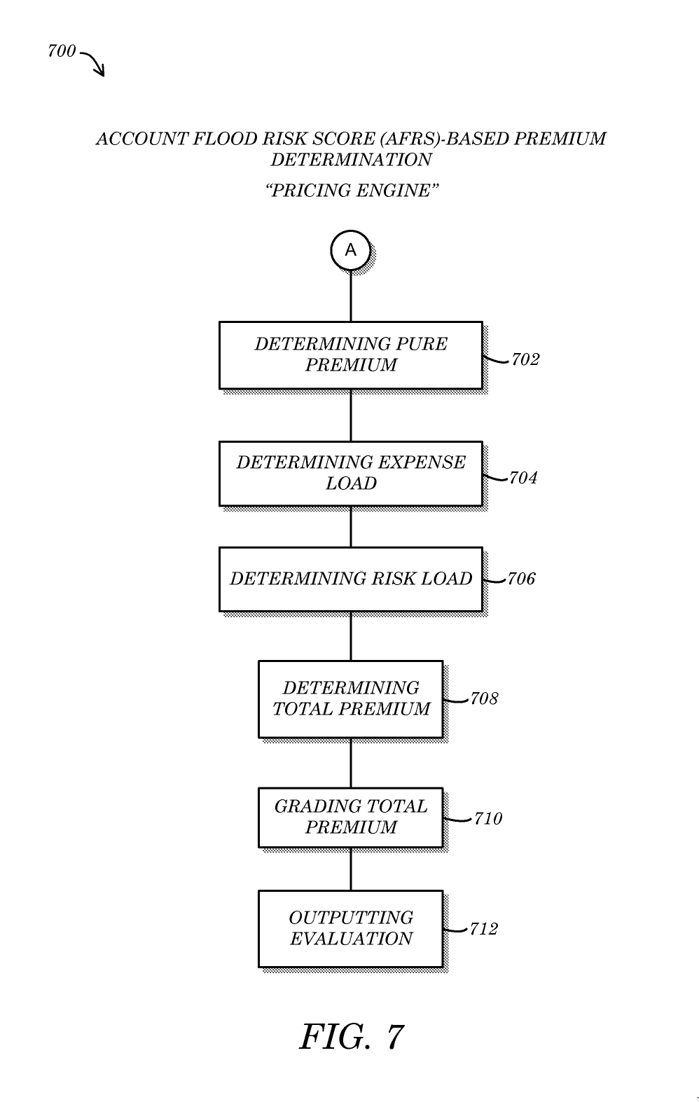

Fewer or more components 102a-n, 104, 106, 110 and/or various configurations of the depicted components 102a-n, 104, 106, 110 may be included in the system 100 without deviating from the scope of embodiments described herein. In some embodiments, the components 102a-n, 104, 106, 110 may be similar in configuration and/or functionality to similarly named and/or numbered components as described herein. In some embodiments, the system 100 (and/or portion thereof) may comprise a risk assessment and/or underwriting program and/or platform programmed and/or otherwise configured to execute, conduct, and/or facilitate any of the various methods 200, 500, 600, 700 of FIG. 2, FIG. 5, FIG. 6, and/or FIG. 7 and/or portions or combinations thereof described herein.

The user devices 102a-n, in some embodiments, may comprise any types or configurations of computing, mobile electronic, network, user, and/or communication devices that are or become known or practicable. The user devices 102a-n may, for example, comprise one or more Personal Computer (PC) devices, computer workstations (e.g., underwriter workstations), tablet computers such as an iPad® manufactured by Apple®, Inc. of Cupertino, Calif., and/or cellular and/or wireless telephones such as an iPhone® (also manufactured by Apple®, Inc.) or an Optimus™ S smart phone manufactured by LG® Electronics, Inc. of San Diego, Calif., and running the Android® operating system from Google®, Inc. of Mountain View, Calif. In some embodiments, the user devices 102a-n may comprise devices owned and/or operated by one or more users such as underwriters, account managers, agents/brokers, customer service representatives, data acquisition partners and/or consultants or service providers, and/or underwriting product customers. According to some embodiments, the user devices 102a-n may communicate with the controller device 110 via the network 104, such as to conduct underwriting inquiries and/or processes utilizing flood risk and/or building (and/or structure) data as described herein.

In some embodiments, the user devices 102a-n may interface with the controller device 110 to effectuate communications (direct or indirect) with one or more other user devices 102a-n (such communication not explicitly shown in FIG. 1), such as may be operated by other users. In some embodiments, the user devices 102a-n may interface with the controller device 110 to effectuate communications (direct or indirect) with the third-party device 106 (such communication also not explicitly shown in FIG. 1). In some embodiments, the user devices 102a-n and/or the third-party device 106 may comprise one or more sensors configured and/or coupled to sense, measure, calculate, and/or otherwise process or determine flood risk and/or building (and/or structure) data. In some embodiments, such sensor data may be provided to the controller device 110, such as for utilization of the flood risk and/or building (and/or structure) data in pricing, risk assessment, line and/or limit setting, quoting, and/or selling or re-selling an underwriting product.

The network 104 may, according to some embodiments, comprise a Local Area Network (LAN; wireless and/or wired), cellular telephone, Bluetooth®, and/or Radio Frequency (RF) network with communication links between the controller device 110, the user devices 102a-n, and/or the third-party device 106. In some embodiments, the network 104 may comprise direct communications links between any or all of the components 102a-n, 106, 110 of the system 100. The user devices 102a-n may, for example, be directly interfaced or connected to one or more of the controller device 110 and/or the third-party device 106 via one or more wires, cables, wireless links, and/or other network components, such network components (e.g., communication links) comprising portions of the network 104. In some embodiments, the network 104 may comprise one or many other links or network components other than those depicted in FIG. 1. The user devices 102a-n may, for example, be connected to the controller device 110 via various cell towers, routers, repeaters, ports, switches, and/or other network components that comprise the Internet and/or a cellular telephone (and/or Public Switched Telephone Network (PSTN)) network, and which comprise portions of the network 104.

While the network 104 is depicted in FIG. 1 as a single object, the network 104 may comprise any number, type, and/or configuration of networks that is or becomes known or practicable. According to some embodiments, the network 104 may comprise a conglomeration of different sub-networks and/or network components interconnected, directly or indirectly, by the components 102a-n, 106, 110 of the system 100. The network 104 may comprise one or more cellular telephone networks with communication links between the user devices 102a-n and the controller device 110, for example, and/or may comprise the Internet, with communication links between the controller device 110 and the third-party device 106, for example.

The third-party device 106, in some embodiments, may comprise any type or configuration a computerized processing device such as a PC, laptop computer, computer server, database system, and/or other electronic device, devices, or any combination thereof. In some embodiments, the third-party device 106 may be owned and/or operated by a third-party (i.e., an entity different than any entity owning and/or operating either the user devices 102a-n or the controller device 110). The third-party device 106 may, for example, be owned and/or operated by a data and/or data service provider such as a municipality, mapping service, surveying entity, etc. In some embodiments, the third-party device 106 may supply and/or provide data such as flood risk and/or building (and/or structure) and/or other data to the controller device 110 and/or the user devices 102a-n. In some embodiments, the third-party device 106 may comprise a plurality of devices and/or may be associated with a plurality of third-party entities.

In some embodiments, the controller device 110 may comprise an electronic and/or computerized controller device such as a computer server communicatively coupled to interface with the user devices 102a-n and/or the third-party device 106 (directly and/or indirectly). The controller device 110 may, for example, comprise one or more PowerEdge™ M910 blade servers manufactured by Dell®, Inc. of Round Rock, Tex. which may include one or more Eight-Core Intel® Xeon® 7500 Series electronic processing devices. According to some embodiments, the controller device 110 may be located remote from one or more of the user devices 102a-n and/or the third-party device 106. The controller device 110 may also or alternatively comprise a plurality of electronic processing devices located at one or more various sites and/or locations.

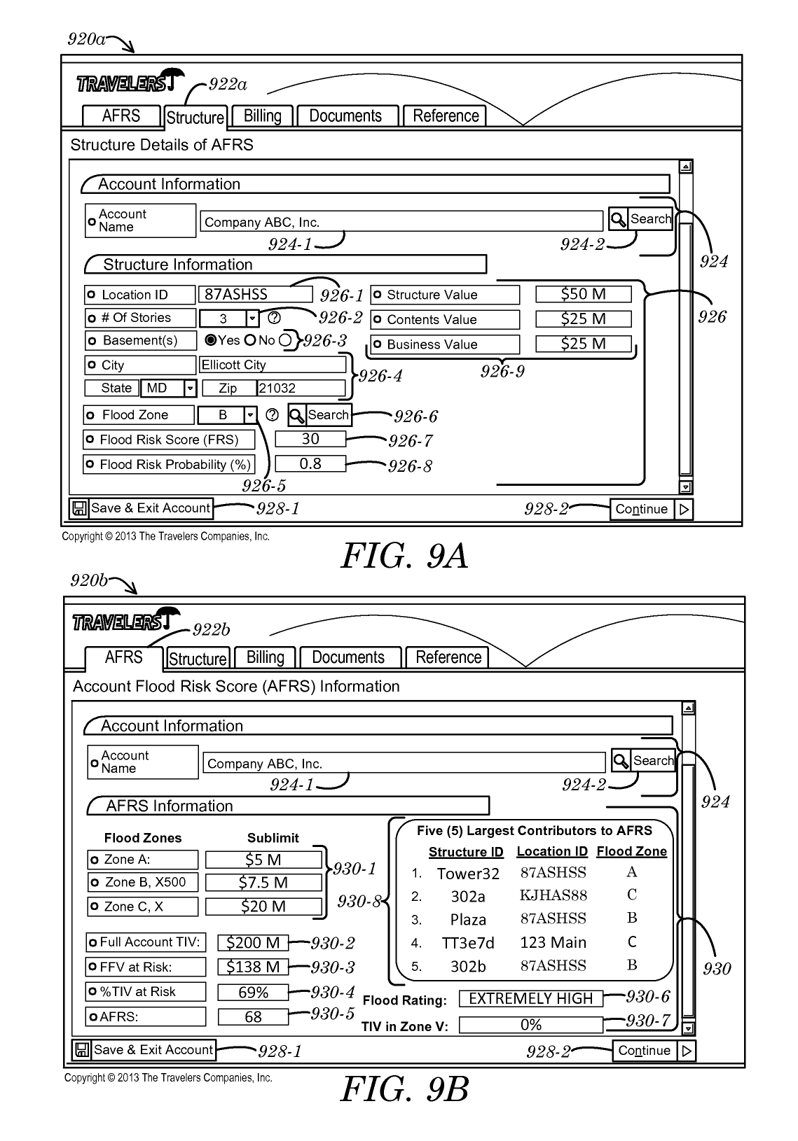

According to some embodiments, the controller device 110 may store and/or execute specially programmed instructions to operate in accordance with embodiments described herein. The controller device 110 may, for example, execute one or more programs that facilitate the utilization of flood risk and/or building (and/or structure) data in the pricing, underwriting, and/or issuance of one or more insurance and/or underwriting products. According to some embodiments, the controller device 110 may comprise a computerized processing device such as a PC, laptop computer, computer server, and/or other electronic device to manage and/or facilitate transactions and/or communications regarding the user devices 102a-n. An underwriter (and/or customer, client, or company) may, for example, utilize the controller device 110 to (i) price and/or underwrite one or more products such as insurance, indemnity, and/or surety products, (ii) determine and/or be provided with flood risk and/or building (and/or structure) and/or other information, and/or (iii) provide an interface via which an underwriting entity may manage and/or facilitate underwriting of various products (e.g., in accordance with embodiments described herein; such as the example interfaces 920a-b of FIG. 9A and/or FIG. 9B).

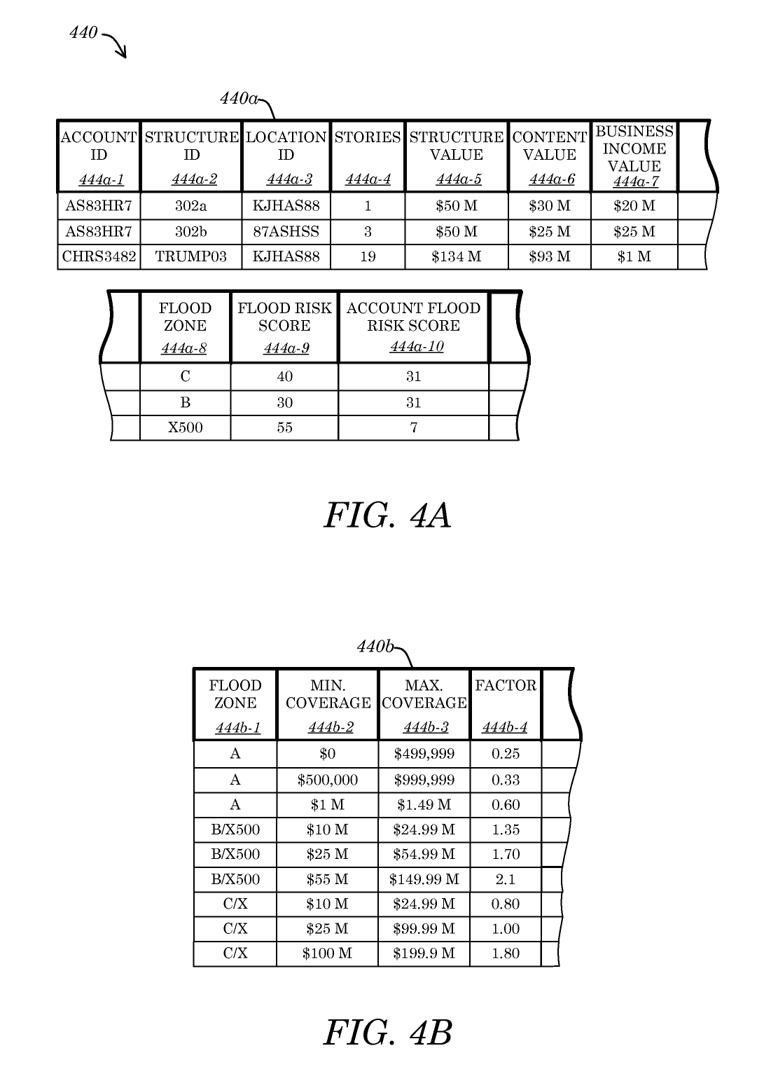

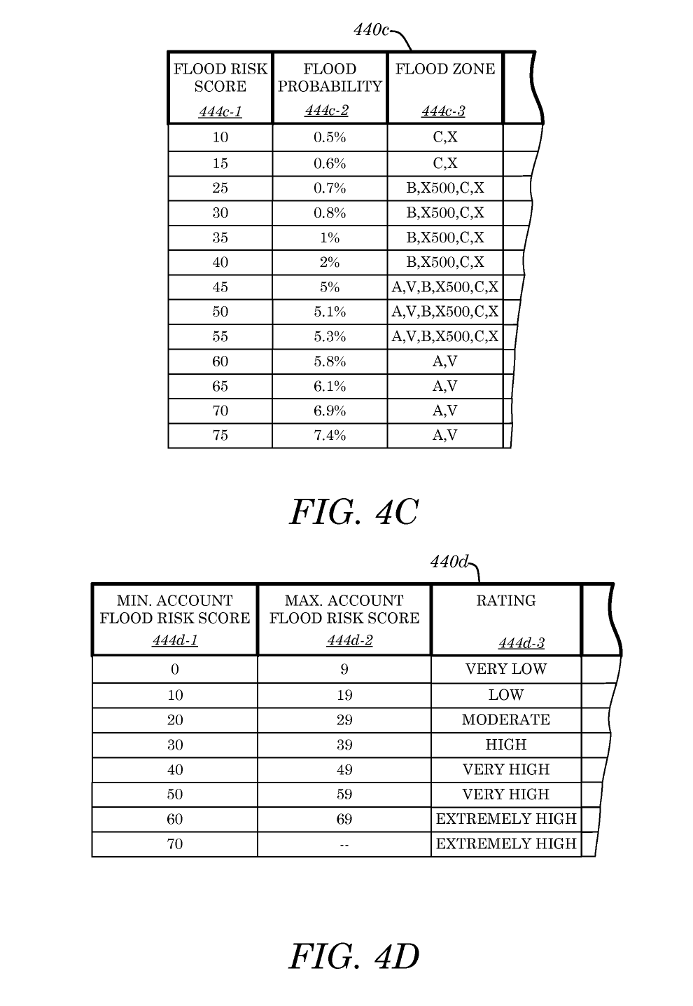

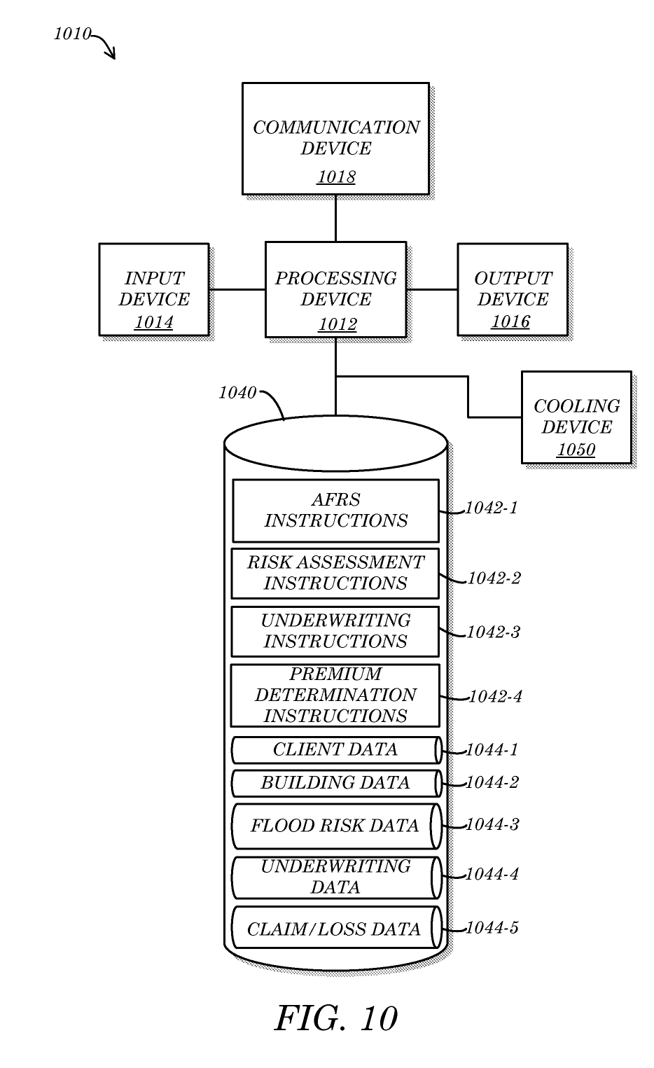

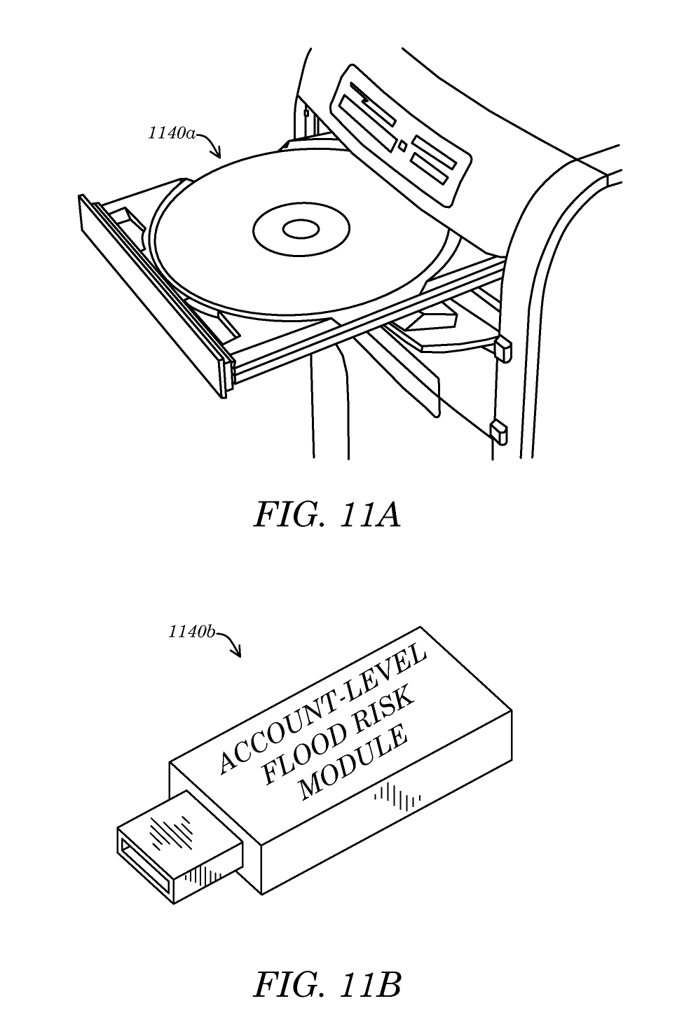

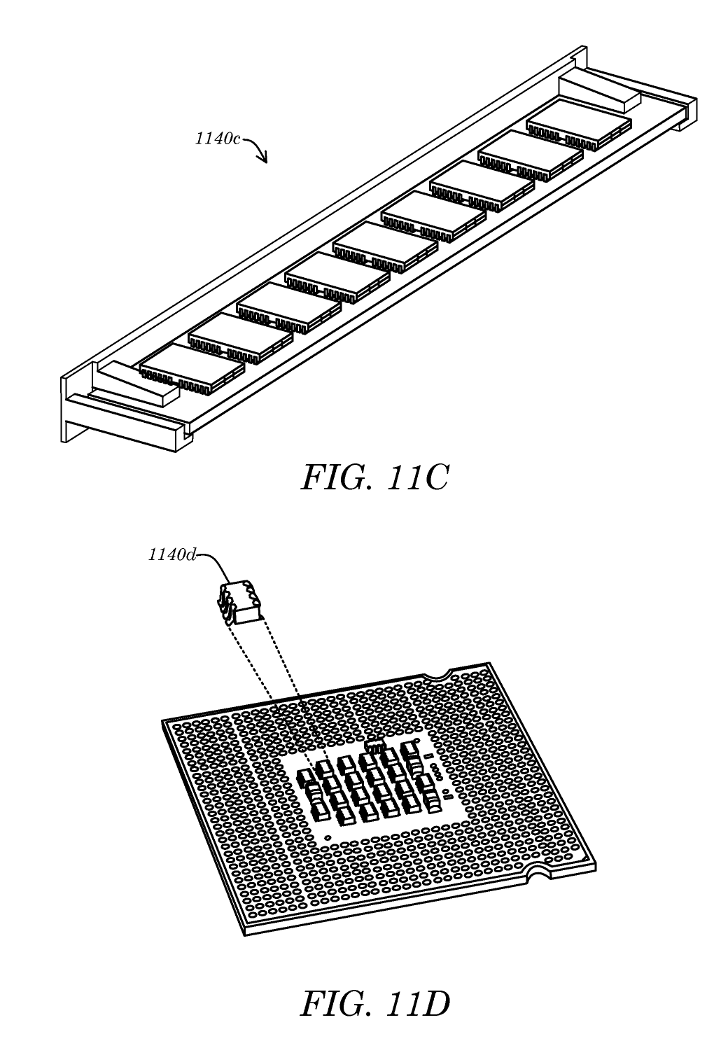

Referring now to FIG. 2, a flow diagram of a method 200 according to some embodiments is shown. In some embodiments, the method 200 may be performed and/or implemented by and/or otherwise associated with one or more specialized and/or specially-programmed computers (e.g., the user devices 102a-n, the third-party device 106, and/or the controller device 110, all of FIG. 1), computer terminals, computer servers, computer systems and/or networks, and/or any combinations thereof (e.g., by one or more insurance company and/or underwriter computers). The process diagrams and flow diagrams described herein do not necessarily imply a fixed order to any depicted actions, steps, and/or procedures, and embodiments may generally be performed in any order that is practicable unless otherwise and specifically noted. Any of the processes and methods described herein may be performed and/or facilitated by hardware, software (including microcode), firmware, or any combination thereof. For example, a storage medium (e.g., a hard disk, Random Access Memory (RAM) device, cache memory device, Universal Serial Bus (USB) mass storage device, and/or Digital Video Disk (DVD); e.g., the data storage devices 440a-d, 1040, 1140a-d of FIG. 4, FIG. 10, FIG. 11A, FIG. 11B, FIG. 11C, and/or FIG. 11D herein) may store thereon instructions that when executed by a machine (such as a computerized processor) result in performance according to any one or more of the embodiments described herein.

According to some embodiments, the method 200 may comprise one or more actions associated with flood risk data 202a and/or building data 202n. The flood risk/building data 202a-n of one or more objects and/or areas that may be related to and/or otherwise associated with an account, customer, insurance product and/or policy, for example, may be determined, calculated, looked-up, retrieved, and/or derived. In some embodiments, the flood risk/building data 202a-n may be gathered as raw data directly from one or more data sources.

As depicted in FIG. 2, flood risk/building data 202a-n from a plurality of data sources may be gathered. In some embodiments, the plurality of flood risk/building data 202a-n may comprise information indicative of flood risk and/or building (and/or other structure or object) characteristics of a single object or area or may comprise information indicative of flood risk and/or building (and/or other structure or object) characteristics of a plurality of objects and/or areas and/or types of objects and/or areas. The flood risk data 202a may, for example, be descriptive of flood zone, flood score, flood characteristic, flood history, and/or other flood-related data—e.g., from a third-party data source such as the Federal Emergency Management Agency (FEMA) and/or CoreLogic® of Irvine, Calif.—and/or may comprise federal, state, regional, private, town/local, and/or municipal data reports, such as United States Geological Survey (USGS) topographic maps and/or the United States Army Corps of Engineers (USACE) maps, reports, permits, and/or studies, providing flood risk and/or other hazard characteristic data at various locations. The building data 202n may comprise, in some embodiments, various private, public, municipal, and/or derived or empirical data descriptive of one or more characteristics of a building and/or other structure or object (e.g., a cache of building materials, an arboreturn or botanical garden, and/or other non-standard objects that may be subject to flood risk and may be insured or insurable). According to some embodiments, the building data 202n may identify how many stories or levels a building has, what the uses (e.g., business operation type, such as indicated by an applicable Standard Industrial Classification (SIC) code) and/or contents of those stories are, a number of stairwells, fire exits, and/or elevators, and/or whether and/or to what extent a building has basements, sub-basements, crawl spaces, and/or other below grade (or below average annual or maximum annual water table or sea level) spaces and/or components.

According to some embodiments, the method 200 may also or alternatively comprise one or more actions associated with flood risk processing 210. As depicted in FIG. 2, for example, some or all of the flood risk/building data 202a-n may be determined, gathered, transmitted and/or received, and/or otherwise obtained for flood risk processing 210. In some embodiments, flood risk processing 210 may comprise aggregation, analysis, calculation, filtering, conversion, encoding and/or decoding (including encrypting and/or decrypting), sorting, ranking, de-duping, and/or any combinations thereof.

According to some embodiments, a processing device may execute specially programmed instructions to process (e.g., the flood risk processing 210) the flood risk/building data 202a-n to define a flood risk metric and/or index. Such a flood risk metric may, for example, be descriptive (in a qualitative and/or quantitative manner) of historic, current, and/or predicted risk levels of an object and/or area having and/or being associated with one or more flood risk and/or building characteristics. In some embodiments, the flood risk metric may be time-dependent (e.g., a level of risk of a sub-basement in a particular flood zone may be determined based on any given time of day), time or frequency-based (e.g., flood events per year or per multi-year period), and/or an average, mean, and/or other statistically normalized value (e.g., an index).

According to some embodiments, there may be a correlation between the risk level associated with a particular flood risk and/or building characteristic (and/or set of characteristics) and weather events when determining risk of loss. For example, a given risk level for a flood risk and/or building characteristic may correlate to a higher risk when there is ice, snow, or heavy slush likely to occur, than when only rain is expected.

In some embodiments, the method 200 may also or alternatively comprise one or more actions associated with insurance underwriting 220. Insurance underwriting 220 may generally comprise any type, variety, and/or configuration of underwriting process and/or functionality that is or becomes known or practicable. Insurance underwriting 220 may comprise, for example, simply consulting a pre-existing rule, criteria, and/or threshold to determine if an insurance product may be offered, underwritten, and/or issued to clients, based on any relevant flood risk/building data 202a-n. One example of an insurance underwriting 220 process may comprise one or more of a risk assessment 230 and/or a premium calculation 240 (e.g., as shown in FIG. 2). In some embodiments, while both the risk assessment 230 and the premium calculation 240 are depicted as being part of an exemplary insurance underwriting 220 procedure, either or both of the risk assessment 230 and the premium calculation 240 may alternatively be part of a different process and/or different type of process (and/or may not be included in the method 200, as is or becomes practicable and/or desirable). In some embodiments, the flood risk/building data 202a-n may be utilized in the insurance underwriting 220 and/or portions or processes thereof (the flood risk/building data 202a-n may be utilized, at least in part for example, to determine, define, identify, recommend, and/or select a coverage type and/or limit and/or type and/or configuration of underwriting product).

In some embodiments, the flood risk/building data 202a-n and/or a result of the flood risk processing 210 may be determined and utilized to conduct the risk assessment 230 for any of a variety of purposes. In some embodiments, the risk assessment 230 may be conducted as part of a rating process for determining how to structure an insurance product and/or offering. A “rating engine” utilized in an insurance underwriting process may, for example, retrieve a flood risk metric (e.g., provided as a result of the flood risk processing 210) for input into a calculation (and/or series of calculations and/or a mathematical model) to determine a level of risk or the amount of risky behavior likely to be associated with a particular object and/or area (e.g., being associated with one or more particular flood risk and/or building characteristics). In some embodiments, how close a customer's property is to a river may correspond to a high risk metric associated with that client/customer. In some embodiments, the risk assessment 230 may comprise determining that a client views and/or utilizes flood risk information (e.g., made available to the client via the insurance company and/or a third-party). In some embodiments, the risk assessment 230 (and/or the method 200) may comprise providing risk control recommendations (e.g., recommendations and/or suggestions directed to reduction of risk, premiums, loss, etc.).

According to some embodiments, the method 200 may also or alternatively comprise one or more actions associated with premium calculation 240 (e.g., which may be part of the insurance underwriting 220). In the case that the method 200 comprises the insurance underwriting 220 process, for example, the premium calculation 240 may be utilized by a “pricing engine” to calculate (and/or look-up or otherwise determine) an appropriate premium to charge for an insurance policy associated with the object and/or area for which the flood risk/building data 202a-n was collected and for which the risk assessment 230 was performed. In some embodiments, the object and/or area analyzed may comprise an object and/or area for which an insurance product is sought (e.g., the analyzed object may comprise a property for which a property insurance policy is desired or a business for which business insurance is desired). According to some embodiments, the object and/or area analyzed may be an object and/or area other than the object and/or area for which insurance is sought (e.g., the analyzed object and/or area may comprise a levy or drainage pump in proximity to the property for which the property insurance policy is desired).

According to some embodiments, the method 200 may also or alternatively comprise one or more actions associated with insurance policy quote and/or issuance 250. Once a policy has been rated, priced, or quoted and the client has accepted the coverage terms, the insurance company may, for example, bind and issue the policy by hard copy and/or electronically to the client/insured. In some embodiments, the quoted and/or issued policy may comprise a personal insurance policy, such as a property damage and/or liability policy, and/or a business insurance policy, such as a business liability policy, and/or a property damage policy.

In general, a client/customer may visit a website and/or an insurance agent, for example, provide the needed information about the client and type of desired insurance, and request an insurance policy and/or product. According to some embodiments, the insurance underwriting 220 may be performed utilizing information about the potential client and the policy may be issued as a result thereof. Insurance coverage may, for example, be evaluated, rated, priced, and/or sold to one or more clients, at least in part, based on the flood risk/building data 202a-n. In some embodiments, an insurance company may have the potential client indicate electronically, on-line, or otherwise whether they have any flood risk, building, and/or location-sensing (e.g., telematics) devices (and/or which specific devices they have) and/or whether they are willing to install them or have them installed. In some embodiments, this may be done by check boxes, radio buttons, or other form of data input/selection, on a web page and/or via a mobile device application.

In some embodiments, the method 200 may comprise telematics data gathering, at 252. In the case that a client desires to have telematics data monitored, recorded, and/or analyzed, for example, not only may such a desire or willingness affect policy pricing (e.g., affect the premium calculation 240), but such a desire or willingness may also cause, trigger, and/or facilitate the transmitting and/or receiving, gathering, retrieving, and/or otherwise obtaining flood risk/building data 202a-n from one or more telematics devices. As depicted in FIG. 2, results of the telematics data gathering at 252 may be utilized to affect the flood risk processing 210, the risk assessment 230, and/or the premium calculation 240 (and/or otherwise may affect the insurance underwriting 220).

According to some embodiments, the method 200 may also or alternatively comprise one or more actions associated with claims 260. In the insurance context, for example, after an insurance product is provided and/or policy is issued (e.g., via the insurance policy quote and issuance 250), and/or during or after telematics data gathering 252, one or more insurance claims 260 may be filed against the product/policy. In some embodiments, such as in the case that a first object associated with the insurance policy is somehow involved with one or more insurance claims 260, the flood risk/building data 202a-n of the object or related objects may be gathered and/or otherwise obtained. According to some embodiments, such flood risk/building data 202a-n may comprise data indicative of a level of risk of the object and/or area (or area in which the object was located) at the time of casualty or loss (e.g., as defined by the one or more claims 260). Information on claims 260 may be provided to flood risk processing 210, risk assessment 230, and/or premium calculation 240 to update, improve, and/or enhance these procedures and/or associated software and/or devices. In some embodiments, flood risk/building data 202a-n may be utilized to determine, inform, define, and/or facilitate a determination or allocation of responsibility related to a loss (e.g., the flood risk/building data 202a-n may be utilized to determine an allocation of weighted liability amongst those involved in the incident(s) associated with the loss).

In some embodiments, the method 200 may also or alternatively comprise insurance policy renewal review 270. Flood risk/building data 202a-n may be utilized, for example, to determine if and/or how an existing insurance policy (e.g., provided via the insurance policy quote and issuance 250) may be renewed. According to some embodiments, such as in the case that a client is involved with and/or in charge of (e.g., responsible for) providing the flood risk/building data 202a-n (e.g., such as location data indicative of one or more particular property, building, and/or structure attributes), a review may be conducted to determine if the correct amount, frequency, and/or type or quality of the flood risk/building data 202a-n was indeed provided by the client during the original term of the policy. In the case that the flood risk/building data 202a-n was lacking, the policy may not, for example, be renewed and/or any discount received by the client for providing the flood risk/building data 202a-n may be revoked or reduced. In some embodiments, the client may be offered a discount for having certain sensing devices or being willing to install them or have them installed (or be willing to adhere to certain thresholds based on measurements from such devices). In some embodiments, analysis of the received flood risk/building data 202a-n in association with the policy may be utilized to determine if the client conformed to various criteria and/or rules set forth in the original policy. In the case that the client satisfied applicable policy requirements (e.g., as verified by received flood risk/building data 202a-n), the policy may be eligible for renewal and/or discounts. In the case that deviations from policy requirements are determined (e.g., based on the flood risk/building data 202a-n), the policy may not be eligible for renewal, a different policy may be applicable, and/or one or more surcharges and/or other penalties may be applied.

According to some embodiments, the method 200 may comprise one or more actions associated with risk/loss control 280. Any or all data (e.g., flood risk/building data 202a-n and/or other data) gathered as part of a process for claims 260, for example, may be gathered, collected, and/or analyzed to determine how (if at all) one or more of a rating engine (e.g., the risk assessment 230), a pricing engine (e.g., the premium calculation 240), the insurance underwriting 220, and/or the flood risk processing 210, should be updated to reflect actual and/or realized risk, costs, and/or other issues associated with the flood risk/building data 202a-n. Results of the risk/loss control 280 may, according to some embodiments, be fed back into the method 200 to refine the risk assessment 230, the premium calculation 240 (e.g., for subsequent insurance queries and/or calculations), the insurance policy renewal review 270 (e.g., a re-calculation of an existing policy for which the one or more claims 260 were filed), and/or the flood risk processing 210 to appropriately scale the output of the risk assessment 230.

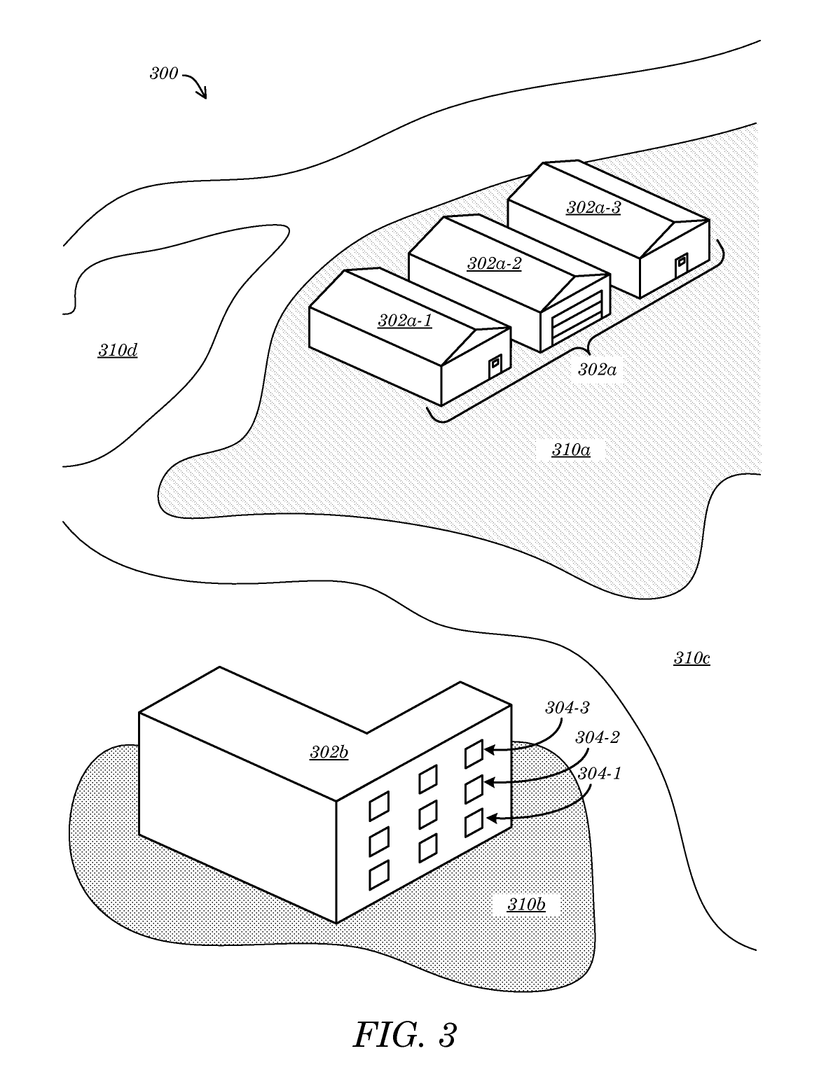

Turning now to FIG. 3, a perspective view of an example location 300 according to some embodiments is shown. The example location 300 may, for example, depict location information descriptive of one or more objects 302a-b. In some embodiments, the objects 302a-b may comprise buildings (as depicted), non-building structures (e.g., water and/or cell-towers), and/or other objects associated with a particular client, customer (and/or potential client or customer), account-holder, and/or account. The structures 302a-b may, for example, comprise objects for which one or more insurance and/or underwriting products are desired (e.g., for purchase and/or analysis). According to some embodiments, a first object 302a may comprise a plurality of sub-objects 302a-1, 302a-2, 302a-3. As depicted in FIG. 3 for purposes of example only, the sub-objects 302a-1, 302a-2, 302a-3 may comprise and/or define a suite, portfolio, and/or grouping of buildings (or other objects)—e.g., single-story buildings as depicted in FIG. 3.

According to some embodiments, a second object 302b may comprise and/or define a multi-story building, or a portion thereof. The second object 302b, for example, may comprise and/or define a first story 304-1, a second story 304-2, and/or a third story 304-3. In some embodiments, the stories 304-1, 304-2, 304-3 may be defined based on elevation and/or height data, such as elevations of the respective floors with respect to ground level (e.g., grade), sea level, average and/or maximum water-table elevations (know or predicted), and/or another datum.

In some embodiments, the objects 302a-b may be associated with and/or disposed in or on one or more flood zones 310a-d. The flood zones 310a-d may, for example, comprise one or more FEMA flood zones such as one or more FEMA “Moderate to Low Risk Areas” (flood zones B, X500 and X (shaded) or C and X (unshaded)), FEMA “High Risk Areas” (flood zones A, AE, A1-30, AH, AO, AR, or A99), FEMA “High Risk—Coastal Areas” (flood zones V, VE, or V1-30), and/or FEMA “Undetermined Risk Areas” (flood zone D). In some embodiments, the assigned and/or associated flood zone for a particular object 302a-b may be determined via utilization of one or more third-party data sources such as a FEMA Flood Insurance Rate Map (FIRM) and/or from a third-party information service such as the CoreLogic® Flood Services provided by CoreLogic® of Irvine, Calif.

According to some embodiments, the first object 302a may be situated in a first flood zone 310a which may, for example, comprise a FEMA flood zone designation of “C” (e.g., an area of minimal flood hazard—above the five hundred year (500-yr) flood level). In some embodiments, the second object 302b may be situated in a second flood zone 310b such as may comprise, for example, a FEMA flood zone designation of “B” (e.g., an area of moderate flood hazard—between the one hundred year (100-yr) and five hundred year (500-yr) flood levels). In some embodiments, one or more other flood zones 310c-d may be disposed between and/or adjacent to the first flood zone 310a and/or the second flood zone 310b.

In some embodiments, information descriptive of the flood zones 310a-d and/or objects 302a-b may be gathered, stored, processed, and/or utilized such as to derive, define, and/or otherwise indentify various insurance and/or underwriting determinations. Such information may, for example, be stored and/or related in accordance with various specialized associations (e.g., in a database) to facilitate a determination of whether to underwrite a particular property, object, and/or account (and/or to what extent such underwriting is desired to occur).

Referring to FIG. 4A, FIG. 4B, FIG. 4C, and FIG. 4D, for example, diagrams of an example data storage structure 440 according to some embodiments are shown. In some embodiments, the data storage structure 440 may comprise a plurality of data tables such as a structure table 440a, a flood zone factor table 440b, a Flood Risk Score (FRS) table 440c, and/or an AFRS table 440d. The data tables 440a-d may, for example, be utilized (e.g., at 504, 506, and/or 508 of the method 500 of FIG. 5) to determine and/or utilize various flood risk and/or building data (e.g., the flood risk/building data 202a-n of FIG. 2), such as to assess, price, quote, sell, renew, revise, and/or re-sell one or more underwriting products.

The structure table 440a may comprise, in accordance with some embodiments, an account IDentifier (ID) field 444a-1, a structure ID field 444a-2, a location ID field 444a-3, a stories field 444a-4, a structure value field 444a-5, a content value field 444a-6, a business income value field 444a-7, a flood zone field 444a-8, a FRS field 444a-9, and/or an AFRS field 444a-10. Any or all of the ID fields 444a-1, 444a-2, 444a-3 may generally store any type of identifier that is or becomes desirable or practicable (e.g., a unique identifier, an alphanumeric identifier, and/or an encoded identifier). In some embodiments, the location ID field 444a-3 may comprise data descriptive and/or indicative of a certified location (e.g., a uniquely-identified geo-locational point or object). The first row of the structure table 440a may correspond to a structure ID of “302a” (stored in the structure ID field 444a-2) that identifies the first object 302a of FIG. 3, for example, and/or the second row may correspond to a structure ID of “302b” (stored in the structure ID field 444a-2) that identifies the second object 302b of FIG. 3. Also as depicted for exemplary purposes, both structures 302a, 302b are associated with the same account ID “AS83HR7” (stored in the account ID field 444a-1). Similarly, and also for purposes of example only, the first structure 302a is indicated as having a single (1) story (stored in the stories field 444a-4) while the second structure 302b is indicated as having three (3) stories (stored in the stories field 444a-4), e.g., the stories 304-1, 304-2, 304-3 of FIG. 3.

The location ID field 444a-3 may, in some embodiments, store a certified location number, certificate number, code, and/or value as defined in commonly-assigned U.S. patent application Ser. No. 13/836,429 filed on Mar. 15, 2013 and titled “SYSTEMS AND METHODS FOR CERTIFIED LOCATION DATA COLLECTION, MANAGEMENT, AND UTILIZATION”, the certified location concepts and descriptions of which are hereby incorporated by reference herein. In such a manner, for example, aggregate insurance coverage and/or exposure (e.g., flood risk) at a specific and/or unique geo-location may readily be determined. As depicted for example only in FIG. 4A, the first structure 302a is indicated as existing at the same certified location “KJHAS88” (e.g., same address, physical structure, land parcel, polygon, etc.) as the third structure “TRUMP03”.

In some embodiments, the stories field 444a-4 may store an indication of a number of stories, levels, and/or floors (or other elevation and/or height data) for a particular structure and/or property or other object. According to some embodiments, the structure value field 444a-5, the content value field 444a-6, and/or the business income value field 444a-7 may store indications of one or more monetary values (e.g., acquisition, sales, and/or replacement value) and/or insurance coverage amounts (actual, desired, and/or potential) for structural losses, content losses, and/or business interruption losses for a particular structure and/or property or other object, respectively. In some embodiments, the flood zone field 444a-8 may store an indication of one or more flood zones (e.g., FEMA flood zones) for a particular structure and/or property or other object, and/or the FRS field 444a-9 may store an indication of a derived and/or third-party risk score value for a particular structure and/or property or other object (e.g., derived from and/or based on the value stored in the respective flood zone field 444a-8). In some embodiments, the AFRS field 444a-10 may store an indication of an AFRS value calculated and/or determined for a particular account, property, customer, structure, location, object, and/or particular groupings thereof. The AFRS field 444a-10 may store, for example, an AFRS value determined at 508 of the method 500 of FIG. 5 herein.

The flood zone factor table 440b may comprise, in accordance with some embodiments, a flood zone field 444b-1, a minimum coverage field 444b-2, a maximum coverage field 444b-3, and/or a factor field 444b-4. The flood zone field 444b-1 may store flood zone data such as FEMA flood zone data as described herein. The minimum coverage field 444b-2 and the maximum coverage field 444b-3 may, in some embodiments, store related indications of respective minimum and maximum coverage limits defining a plurality of coverage ranges (e.g., for the first row of the flood zone factor table 440b—a coverage range of zero dollars ($0) to four hundred ninety-nine thousand, nine hundred ninety-nine dollars ($499,999)). In some embodiments, the factor field 444b-4 may store an indication of a factor (e.g., for use in calculations and/or determinations regarding flood risk as described herein) that corresponds to a particular flood zone and a particular range of coverage values. According to some embodiments, the flood zone field 444b-1 may store flood zone data corresponding to data stored in the flood zone field 444a-8 of the structure table 440a and/or may comprise a key and/or link between the structure table 440a and the flood zone factor table 440b. In such a manner, for example, an applicable flood zone factor stored in the factor field 444b-4 for any given object (e.g., any particular structure ID stored in the structure ID field 444a-2), any given account (e.g., any particular account ID stored in the account ID field 444a-1), and/or any given location (e.g., a certified location and/or any particular location ID stored in the location ID field 444a-3) may be determined based on the flood zone and/or coverage amount(s) thereof.

The FRS table 440c may comprise, in accordance with some embodiments, an FRS field 444c-1, a flood probability field 444c-2, and/or a flood zone field 444c-3. The FRS field 444c-1 may store FRS data, such as one or more FRS scores, rankings, weights, ranges, and/or other indicators such as may be derived, for example, from FEMA flood zone data and/or acquired from one or more third-party data sources. The flood probability field 444c-2 may, in some embodiments, store values representing the probability (e.g., estimated relative probability) and/or likelihood of a flood event occurring (and/or a flood event of a particular size or exceeding a particular threshold) for a particular property, structure, account, location, and/or object. In some embodiments, the flood zone field 444c-3 may store an indication of one or more flood zones for which the respective FRS and/or probability of flooding are applicable. As depicted in FIG. 4C, the FRS may overlap flood zone designations. A “low risk” flood zone (e.g., C or X) may include objects having an FRS between ten (10) and forty-five (45), for example, while a “medium risk” flood zone (e.g., B or X500) may include objects having an FRS between twenty-five (25) and forty-five (45). Thus, embodiments herein that utilize the FRS to produce underwriting determinations are likely to be more accurate than typical flood risk assessments that rely solely on FEMA flood zone data. Such increased accuracy may, for example, provide an opportunity to pursue increased profits in the selling and/or reselling of underwriting products consummated in accordance with embodiments herein. According to some embodiments, the FRS field 444c-1 may store FRS data corresponding to data stored in the FRS field 444a-9 of the structure table 440a and/or may comprise a key and/or link between the structure table 440a and the FRS table 440c. In such a manner, for example, an applicable probability (e.g., estimated relative probability) of flooding stored in the flood probability field 444c-2 for any given object (e.g., any particular structure ID stored in the structure ID field 444a-2), any given account (e.g., any particular account ID stored in the account ID field 444a-1) and/or any given location (e.g., a certified location and/or any particular location ID stored in the location ID field 444a-3) may be determined based on the FRS thereof.

The AFRS table 440d may comprise, in accordance with some embodiments, a minimum AFRS field 444d-1, a maximum AFRS field 444d-2, and/or a rating field 444d-3. The minimum AFRS field 444d-1 and the maximum AFRS field 444d-2 may, in some embodiments, store related indications of respective minimum and maximum AFRS limits defining a plurality of AFRS ranges (e.g., for the first row of the AFRS table 440d—an AFRS range of zero (0) to nine (9)). In some embodiments, the rating field 444d-3 may store an indication of a flood risk rating, metric, and/or qualitative determination which is applicable to the respective AFRS range. According to some embodiments, the AFRS fields 444d-1, 444d-2 may be utilized to lookup, for AFRS data corresponding to data stored in the AFRS field 444a-10 of the structure table 440a, an applicable and/or corresponding rating stored in the rating field 444d-3. In such a manner, for example, an applicable rating stored in the rating field 444d-3 that corresponds to any given object (e.g., any particular structure ID stored in the structure ID field 444a-2), any given account (e.g., any particular account ID stored in the account ID field 444a-1) and/or any given location (e.g., a certified location and/or any particular location ID stored in the location ID field 444a-3) may be determined based on the AFRS thereof.

In some embodiments, fewer or more data fields than are shown may be associated with the data tables 440a-d. Only a portion of one or more databases and/or other data stores is necessarily shown in any of FIG. 4A, FIG. 4B, FIG. 4C, and/or FIG. 4D, for example, and other database fields, columns, structures, orientations, quantities, and/or configurations may be utilized without deviating from the scope of some embodiments. Further, the data shown in the various data fields is provided solely for exemplary and illustrative purposes and does not limit the scope of embodiments described herein nor imply that any such data is accurate.

Turning now to FIG. 5, a flow diagram of a method 500 according to some embodiments is shown. In some embodiments, the method 500 may be implemented, facilitated, and/or performed by or otherwise associated with the system 100 of FIG. 1 herein. In some embodiments, the method 500 may be associated with the method 200 of FIG. 2. The method 500 may, for example, comprise a portion of the method 200 such as the flood risk processing 210, the risk assessment 230, and/or the insurance underwriting 220, and/or any portions and/or combinations thereof.

According to some embodiments, the method 500 may comprise determining an account, at 502. In a product underwriting scenario, for example, a customer (and/or potential customer) may login to a website and/or via a mobile device application and/or may otherwise provide (e.g., send and/or transmit) identifying information such as an indication of an account ID, account name, an address, policy number, etc. (e.g., which may accordingly be received by a server, controller device, apparatus, and/or system as described herein). In some embodiments, such as in the case that an underwriter, Customer Service Representative (CSR), and/or agent (e.g., an insurance agent) enters data on behalf of (or otherwise in association with) a customer/potential customer, the identifying data may be received from an underwriting and/or agent workstation and/or such devices may be utilized to lookup and/or search for data identifying one or more accounts. According to some embodiments, an account ID such as the account ID “AS83HR7” in the example account ID field 444a-1 of the structure table 440a of FIG. 4A may be received, looked up (e.g., based on related and/or corresponding information received and/or provided, such as an account address), and/or otherwise determined.

In some embodiments, the method 500 may comprise determining first and second structures (and/or objects, properties, etc.) associated with the account, at 504. In accordance with the continuing example including the example location 300 of FIG. 3 and the example data storage structure 440 of FIG. 4A, FIG. 4B, FIG. 4C, and FIG. 4D herein, the account ID “AS83HR7” (stored in the account ID field 444a-1) may be associated with both the first object 302a (structure ID “302a” being stored in the first row of the structure ID field 444a-2) and the second object 302b (structure ID “302b” being stored in the second row of the structure ID field 444a-2), both as depicted in FIG. 3. In some embodiments, such as in the case that pre-stored data identifying the objects 302a-b is not available, some or all of the data descriptive of a relationship between the account and the objects 302a-b may be received (e.g., from a user and/or customer device and/or from a third-party). Although the objects 302a-b are depicted for exemplary purposes as being in relative proximity to each other, there is no limitation in accordance with some embodiments regarding the spatial relationship between the two objects 302a-b. The two objects 302a-b may, for example, be situated in different cities, counties, states, and/or other disparate geographical locations.

According to some embodiments, the method 500 may comprise determining, for each of the structures (and/or objects, properties, etc.): (1) a total insurance coverage, (2) a FRS, and (3) a First-Floor Value (FFV), at 506. Data descriptive of each desired metric may, for example, be received, looked up, retrieved (e.g., from a third-party database), and/or calculated (e.g., based on and/or utilizing one or more stored rules, parameters, and/or formulas of models). In some embodiments, the total insurance coverage may comprise the total actual coverage for a current policy and/or pre-existing account and/or may comprise a total desired level of coverage for a prospective policy, account, and/or customer. In some embodiments, the total insurance coverage may be received, provided, stored, and/or determined as one or more portions, parts, and/or components. As depicted as being stored in the structure table 440a of FIG. 4A, for example, a total insurance coverage of one hundred million dollars ($100 M) for the first object 302a may be expressed in sub-terms of a structural insurance coverage of fifty million dollars ($50 M; stored in the structure value field 444a-5), a contents insurance coverage of thirty million dollars ($30 M; stored in the content value field 444a-6), and/or a Business Interruption Insurance (BII) coverage of twenty million dollars ($20 M; stored in the business income value field 444a-7).

According to some embodiments, the FRS may be received and/or determined utilizing a third-party service such as the CoreLogic® Flood Services. Based on flood zone and/or other location information for the first object 302a, for example, a FRS may be retrieved, obtained, and/or otherwise determined. In some embodiments, as described herein, the FRS (e.g., stored in the FRS field 444a-9 of the structure table 440a) may provide a substantially differing metric than standard FEMA flood zone designations. Indeed, some flood risks (e.g., based on a FRS) in a “low risk” FEMA zone may actually be determined and/or estimated to be higher risk than a “moderate risk” or even a “high risk” FEMA zone, and vice versa. In the example of FIG. 4A, for example, the first object 302a, although classified in a “low risk” FEMA flood zone of “C”, is indicated as having a higher FRS (forty (40)) than the second object 302b classified in a “moderate risk” FEMA flood zone of “B” (e.g., a FRS of only thirty (30)). According to some embodiments, the FRS for a given object (e.g., stored in the FRS field 444a-9 of the structure table 440a) may be adjusted based on various factors such as the flood zone and/or the total insurance coverage (e.g., an adjusted FRS may be determined). In some embodiments, for example, the flood zone and total insurance coverage for an object may be utilized to lookup a factor, “F”, such as the factor stored in the factor field 444b-4 of the flood zone factor table 440b. In such embodiments, the FRS and the factor may be utilized to calculate and/or determine an adjusted FRS, “AdjFRSₛ”, for a particular object, e.g., in accordance with the following formula:

AdjFRS=FRSₛ*F; (1)
where FRSₛ is the FRS for a particular object (e.g., stored in the FRS field 444a-9).

In the continuing example, the adjusted FRS for the first object 302a, utilizing equation (1), would equal:

AdjFRS₁=FRS₁*F=40*1.8=72; (A)
where the flood zone factor of one and eight tenths (1.8) is stored in the ninth (9^{th}) row of the factor field 444b-4, in correlation to the flood zone (zone “C”) and total insurance coverage range band of one hundred million dollars ($100 M) to one hundred and ninety-nine million dollars ($199 M) for which the total insurance coverage (the sum of the values stored in the structure value field 444a-5, the content value field 444a-6, and the business income value field 444a-7—equals one hundred million dollars ($100 M)) for the first object 302a corresponds.

Similarly, in the example, the adjusted FRS for the second object 302b, utilizing equation (1), would equal:

AdjFRS₂=FRS₂*F=30*2.1=63; (B)
where the flood zone factor of two and one tenth (2.1) is stored in the sixth (6^{th}) row of the factor field 444b-4, in correlation to the flood zone (zone “B”) and total insurance coverage range band of fifty-five million dollars ($55 M) to one hundred forty-nine million dollars ($149 M) for which the total insurance coverage (the sum of the values stored in the structure value field 444a-5, the content value field 444a-6, and the business income value field 444a-7—equals one hundred million dollars ($100 M)) for the second object 302b corresponds.

According to some embodiments, the FRS may be adjusted, scaled, and/or otherwise modified based on one or more other factors. The factor, “F”, for example, may be determined based on one or more alternate or additional considerations (e.g., other than or in addition to the coverage amount and/or flood zone designation). In some embodiments, the FRS may be adjusted based on a surge score descriptive of an estimated, historical, and/or potential storm surge risk of a location, structure, and/or other object. Qualitative surge score ratings of “High”, “Medium”, and “Low”, for example, may be associated with (e.g., stored data associations) FRS multipliers of two (2), one and one half (1.5), and one (1), respectively. Storm surge data (such as a storm surge score and/or rating) may, for example, be utilized as (or in addition to) the factor, “F”, in equation (1), to scale and/or adjust a FRS.

In some embodiments, the FFV may be received, looked up, and/or calculated. According to some embodiments, the FFV may be derived and/or calculated based on the total insurance coverage value (and/or components thereof). In some embodiments for example, the FFV for a particular object/structure/building may be calculated based on the number of stories of the object/structure/building (and/or other elevation and/or height data associated therewith), in accordance with the following formulas:

In the case that the number of stories, “n”, equals one (n=1):

FFVₛ=SVₛ+CVₛ+BVₛ, (2)
where FFVₛ is the FFV for a particular object “s”, SVₛ is the structural insurance coverage (stored in the structure value field 444a-5) for the particular object, CVₛ is the contents insurance coverage (stored in the content value field 444a-6) for the particular object, and BVₛ is the BII coverage (stored in the business income value field 444a-7) for the particular object; or

in the case that the number of stories, “n”, is greater than one (n>1):

$${FFV}_{s} = \frac{{SV}_{s}}{n} + \frac{{CV}_{s}}{n} + ( \frac{{BV}_{s}}{n} * f ) , \qquad ( 3 )$$

where f is a gross-up factor of a magnitude that is or becomes desirable and/or practicable.

In the continuing example, the FFV for the first object 302a, utilizing equation (2), would equal:

FFV₁=SV₁+CV₁+BV₁=$50 M+$30 M+$20 M=$100 M. (C)

Similarly, in the example, the adjusted FRS for the second object 302b, utilizing equation (3)—e.g., because the second object 302b comprises more than one story, would equal:

$${FFV}_{2} = \frac{{BV}_{2}}{n} + \frac{{CV}_{2}}{n} + ( \frac{{BV}_{2}}{n} * f ) = \frac{\$50 M}{3} + \frac{\$25 M}{3} + ( \frac{\$25 M}{3} * 2.0 ) = \$41 .67 M . \qquad ( D )$$

According to some embodiments, the FFV may be also or alternatively be based on various at-grade/datum and/or below-grade/datum data associated with an object, structure, and/or property such as whether and/or to what extent such object/structure/property comprises an at-grade, below-grade, below sea level, and/or below water-table portion or feature. In the case of a building, for example, whether and/or to what extent the building has a basement, sub-basement, crawl space, etc. may affect the FFV calculation (e.g., equation (3)). In some embodiments, the number of stories “n” in equation (3) may instead comprise a sum of the number of stories and the number of basement levels or comprise a ratio of number of at-grade and/or below-grade levels to total levels—e.g., first floor level plus basement levels divided by total number of levels. In such embodiments, the title “FFV” may not be entirely descriptive of the calculation and “FFV” may accordingly be identified by one or more different names/titles such as “Ground Level or Below Value (GLBV)”, as is or becomes desirable.

In some embodiments, the method 500 may comprise determining an AFRS for the account (e.g., for the account determined at 502, such as account ID “AS83HR7”), at 508. The AFRS may, for example, be based on the total insurance coverage data, FRS data, and/or FFV data determined at 506. In some embodiments, the AFRS may be based on the adjusted FRS data and/or FFV data determined at 506. According to some embodiments, the AFRS may be derived and/or calculated from a AFRS probability. A formula for the AFRS probability, “P(AFRS)”, in accordance with some embodiments may comprise, for example:

$$P ( AFRS ) = \frac{( \begin{matrix}{FFV}_{1} * \\ P ( {AdjFRS}_{1} )\end{matrix} ) + ( \begin{matrix}{FFV}_{2} * \\ P ( {AdjFRS}_{2} )\end{matrix} ) + … ( \begin{matrix}{FFV}_{x} * \\ P ( {AdjFRS}_{x} )\end{matrix} )}{{FFV}_{TOTAL}} ; \qquad ( 4 )$$

where “P(AdjFRS)” is a probability of flooding associated with a particular AdjFRS and FFV_{TOTAL} is the total FFV for the account (e.g., the sum of all individual FFV values for each object associated with the account).

In the continuing example, the AFRS probability (P(AFRS) would be:

$$P ( AFRS ) = \frac{( {FFV}_{1} * P ( {AdjFRS}_{1} ) ) + ( {FFV}_{2} * P ( {AdjFRS}_{2} ) )}{{FFV}_{1} + {FFV}_{2}} OR \\ P ( AFRS ) = \frac{( \$100 M * 6.9 ) + ( \$41 .67 M * 5.8 )}{\$100 M + \$41 .67 M} = 6.58 ; \qquad ( E )$$

where the probability of the adjusted FRS for the first object 302a (P(AdjFRS₁)) comprises the twelfth (12^{th}) row in the FRS table 440c that corresponds to the AdjFRS₁ of seventy-two (72) from calculation (A), the FFV for the first object 302a (FFV₁) comprises the result of equation (C), the adjusted FRS for the second object 302b (P(AdjFRS₂)) comprises the tenth (10^{th}) row in the FRS table 440c that corresponds to the AdjFRS₂ of sixty-three (63) from calculation (B), and the FFV for the second object 302a (FFV₂) comprises the result of equation (D).

In some embodiments, the AFRS may be determined based on the AFRS probability (P(AFRS). Utilizing the FRS table 440c, for example, the calculated AFRS (e.g., six and fifty-eight hundredths (6.58)) may be looked up to determine a corresponding FRS (e.g., approximately sixty-eight (68)). In some embodiments, this FRS may be utilized as the AFRS (as it was determined based on flood risk data for multiple objects associated with the account). In some embodiments, certain attributes (e.g., building attributes) and/or other data may be utilized to adjust and/or scale the AFRS. An adjusted AFRS may be determined, for example, by multiplying the AFRS by a factor determined based on whether and/or to what extent a building has a basement (or other at-grade or below-grade feature), based on a business operation type, and/or based on a storm surge score or rating.

According to some embodiments, the method 500 may comprise providing, e.g. based on the AFRS (and/or an adjusted AFRS), an indication of an insurance determination, at 510. The AFRS table 440d may, for example, be utilized to determine and/or look up a rating stored in the rating field 444d-3 that corresponds to the determined AFRS (e.g., sixty-eight (68) in the example). In such embodiments, the continuing example may result in a determination the calculated AFRS of sixty-eight (68) corresponds to a qualitative rating of “EXTREMELY HIGH”. In some embodiments, the AFRS table 440d may be utilized to provide perspective to the AFRS. The AFRS scale, weight, and/or meaning or effect, for example, may be different that the FRS scale, meaning, weight, etc. for an individual object. While an FRS of thirty (30) for an individual object may be considered relatively low, for example, an AFRS of thirty (30) may instead be considered “High” (e.g., as depicted in the example data for the AFRS table 440d). In some embodiments, the determination based on the AFRS may comprise a rule, suggestion, recommendation, and/or definitive response to an underwriting and/or insurance question. Based on the AFRS, for example, it may be determined whether or not (and/or to what extent) one or more underwriting products should be offered and/or sold. The AFRS may, for example, allow for account-level determinations regarding insurance exposure, risk, and/or coverage. In some embodiments, the providing may comprise the provision and/or generation and/or outputting of (e.g., a server may cause a mobile device to output) a user interface such as the example graphical user interfaces 920a-b of FIG. 9A and/or FIG. 9B herein. In some embodiments, any or all data input into and/or received by the method 500 may be received via such a user interface.

Referring now to FIG. 6, a flow diagram of a method 600 according to some embodiments is shown. In some embodiments, the method 600 may comprise a flood risk and/or AFRS risk assessment method which may, for example, be described as a “rating engine”. According to some embodiments, the method 600 may be implemented, facilitated, and/or performed by or otherwise associated with the system 100 of FIG. 1 herein. In some embodiments, the method 600 may be associated with the method 200 of FIG. 2. The method 600 may, for example, comprise a portion of the method 200 such as the risk assessment 230.

According to some embodiments, the method 600 may comprise determining one or more loss frequency distributions for a class of objects, at 602 (e.g., 602a-b). In some embodiments, a first loss frequency distribution may be determined, at 602a, based on flood risk and/or AFRS data and/or metrics. Flood risk and/or AFRS data (such as the flood risk/building data 202a-n of FIG. 2) for a class of objects such as a class of property and/or for a particular type of object (such as an orchard) within a class of objects (such as “farms”) may, for example, be analyzed to determine relationships between various flood risk and/or building data and/or metrics and empirical data descriptive of actual insurance losses for such object types and/or classes of objects. A flood risk processing and/or analytics system and/or device (e.g., the controller device 110 as described with respect to FIG. 1 herein) may, according to some embodiments, conduct regression and/or other mathematical analysis on various floor risk metrics to determine and/or identify mathematical relationships that may exist between such metrics and actual sustained losses and/or casualties.

Similarly, at 602b, a second loss frequency distribution may be determined based on non-AFRS data. According to some embodiments, the determining at 602b may comprise a standard or typical loss frequency distribution utilized by an entity (such as an insurance company) to assess risk. The non-AFRS metrics utilized as inputs in the determining at 602b may include, for example, age of a building, proximity to emergency services, etc. In some embodiments, the loss frequency distribution determinations at 602a-b may be combined and/or determined as part of a single comprehensive loss frequency distribution determination. In such a manner, for example, expected total loss probabilities (e.g., taking into account both flood/AFRS and non-AFRS data) for a particular object type and/or class may be determined. In some embodiments, this may establish and/or define a baseline, datum, average, and/or standard with which individual and/or particular risk assessments may be measured.

According to some embodiments, the method 600 may comprise determining one or more loss severity distributions for a class of objects, at 604 (e.g., 604a-b). In some embodiments, a first loss severity distribution may be determined, at 604a, based on flood risk and/or AFRS data and/or metrics. Flood risk and/or AFRS data (such as the flood risk/building data 202a-n of FIG. 2) for a class of objects such as location objects and/or for a particular type of object (such as a drycleaner) may, for example, be analyzed to determine relationships between various flood risk and/or building data and/or metrics and empirical data descriptive of actual insurance losses for such object types and/or classes of objects. A flood risk processing and/or analytics system (e.g., the controller device 110 as described with respect to FIG. 1) may, according to some embodiments, conduct regression and/or other analysis on various (e.g., flood risk and/or building) metrics to determine and/or identify mathematical relationships that may exist between such metrics and actual sustained losses and/or casualties.

Similarly, at 604b, a second loss severity distribution may be determined based on non-AFRS data. According to some embodiments, the determining at 604b may comprise a standard or typical loss severity distribution utilized by an entity (such as an insurance agency) to assess risk. The non-AFRS metrics utilized as inputs in the determining at 604b may include, for example, cost of replacement or repair, ability to self-mitigate loss (e.g., if a building has a fire suppression system and/or automatically closing fire doors, floor drains), etc. In some embodiments, the loss severity distribution determinations at 604a-b may be combined and/or determined as part of a single comprehensive loss severity distribution determination. In such a manner, for example, expected total loss severities (e.g., taking into account both flood risk/AFRS and non-AFRS data) for a particular object type and/or class may be determined. In some embodiments, this may also or alternatively establish and/or define a baseline, datum, average, and/or standard with which individual and/or particular risk assessments may be measured.

In some embodiments, the method 600 may comprise determining one or more expected loss frequency distributions for a specific object (and/or account or other group of objects) in the class of objects, at 606 (e.g., 606a-b). Regression and/or other mathematical analysis performed on the flood risk and/or AFRS loss frequency distribution derived from empirical data, at 602a for example, may identify various flood risk metrics and may mathematically relate such metrics to expected loss occurrences (e.g., based on historical trends). Based on these relationships, a flood risk and/or AFRS loss frequency distribution may be developed at 606a for the specific object (and/or account or other group of objects). In such a manner, for example, known flood risk metrics for a specific object (and/or account or other group of objects) may be utilized to develop an expected distribution (e.g., probability) of occurrence of flood risk-related loss for the specific object (and/or account or other group of objects).

Similarly, regression and/or other mathematical analysis performed on the non-AFRS loss frequency distribution derived from empirical data, at 602b for example, may identify various non-AFRS metrics and may mathematically relate such metrics to expected loss occurrences (e.g., based on historical trends). Based on these relationships, a non-AFRS loss frequency distribution may be developed at 606b for the specific object (and/or account or other group of objects). In such a manner, for example, known non-AFRS metrics for a specific object may be utilized to develop an expected distribution (e.g., probability) of occurrence of non-AFRS-related loss for the specific object (and/or account or other group of objects). In some embodiments, the non-AFRS loss frequency distribution determined at 606b may be similar to a standard or typical loss frequency distribution utilized by an insurer to assess risk.

In some embodiments, the method 600 may comprise determining one or more expected loss severity distributions for a specific object (and/or account or other group of objects) in the class of objects, at 608 (e.g., 608a-b). Regression and/or other mathematical analysis performed on the flood risk and/or AFRS loss severity distribution derived from empirical data, at 604a for example, may identify various flood risk metrics and may mathematically relate such metrics to expected loss severities (e.g., based on historical trends). Based on these relationships, a flood risk and/or AFRS loss severity distribution may be developed at 608a for the specific object (and/or account or other group of objects). In such a manner, for example, known flood risk metrics for a specific object (and/or account or other group of objects) may be utilized to develop an expected severity for occurrences of AFRS-related loss for the specific object (and/or account or other group of objects).

Similarly, regression and/or other mathematical analysis performed on the non-AFRS loss severity distribution derived from empirical data, at 604b for example, may identify various non-AFRS metrics and may mathematically relate such metrics to expected loss severities (e.g., based on historical trends). Based on these relationships, a non-AFRS loss severity distribution may be developed at 608b for the specific object (and/or account or other group of objects). In such a manner, for example, known non-AFRS metrics for a specific object (and/or account or other group of objects) may be utilized to develop an expected severity of occurrences of non-AFRS-related loss for the specific object (and/or account or other group of objects). In some embodiments, the non-AFRS loss severity distribution determined at 608b may be similar to a standard or typical loss frequency distribution utilized by an insurer to assess risk.

It should also be understood that the flood risk and/or AFRS-based determinations 602a, 604a, 606a, 608a and non-AFRS-based determinations 602b, 604b, 606b, 608b are separately depicted in FIG. 6 for ease of illustration of one embodiment descriptive of how flood risk metrics may be included to enhance standard risk assessment procedures. According to some embodiments, the flood risk and/or AFRS-based determinations 602a, 604a, 606a, 608a and non-AFRS-based determinations 602b, 604b, 606b, 608b may indeed be performed separately and/or distinctly in either time or space (e.g., they may be determined by different software and/or hardware modules or components and/or may be performed serially with respect to time). In some embodiments, the flood risk and/or AFRS-based determinations 602a, 604a, 606a, 608a and non-AFRS-based determinations 602b, 604b, 606b, 608b may be incorporated into a single risk assessment process or “engine” that may, for example, comprise a risk assessment software program, package, and/or module.

In some embodiments, the method 600 may also comprise calculating a risk score (e.g., for an object, account, and/or group of objects—e.g., objects related in a manner other than sharing an identical or similar class designation), at 610. According to some embodiments, formulas, charts, and/or tables may be developed that associate various flood risk and/or AFRS and/or non-AFRS metric magnitudes with risk scores. Risk scores for a plurality of flood risk and/or AFRS and/or non-AFRS metrics may be determined, calculated, tabulated, and/or summed to arrive at a total risk score for an object and/or account (e.g., a property, a property feature, a portfolio and/or group of properties and/or objects subject to flood risk) and/or for an object class. According to some embodiments, risk scores may be derived from the flood risk and/or AFRS and/or non-AFRS loss frequency distributions and the flood risk and/or AFRS and/or non-AFRS loss severity distribution determined at 606a-b and 608a-b, respectively. More details on one method for assessing risk are provided in commonly-assigned U.S. Pat. No. 7,330,820 entitled “PREMIUM EVALUATION SYSTEMS AND METHODS,” which issued on Feb. 12, 2008, the risk assessment concepts and descriptions of which are hereby incorporated by reference herein.

In some embodiments, the method 600 may also or alternatively comprise providing various recommendations, suggestions, guidelines, and/or rules directed to reducing and/or minimizing risk, premiums, etc. According to some embodiments, the results of the method 600 may be utilized to determine a premium for an insurance policy for, e.g., a specific object and/or account analyzed. Any or all of the flood risk and/or AFRS and/or non-AFRS loss frequency distributions of 606a-b, the flood risk and/or AFRS and/or non-AFRS loss severity distributions of 608a-b, and the risk score of 610 may, for example, be passed to and/or otherwise utilized by a premium calculation process via the node labeled “A” in FIG. 6.

Turning to FIG. 7, for example, a flow diagram of a method 700 (that may initiate at the node labeled “A”) according to some embodiments is shown. In some embodiments, the method 700 may comprise a flood risk and/or AFRS-based premium determination method which may, for example, be described as a “pricing engine”. According to some embodiments, the method 700 may be implemented, facilitated, and/or performed by or otherwise associated with the system 100 of FIG. 1 herein. In some embodiments, the method 700 may be associated with the method 200 of FIG. 2. The method 700 may, for example, comprise a portion of the method 200 such as the premium calculation 240. Any other technique for calculating an insurance premium that uses AFRS information described herein may be utilized, in accordance with some embodiments, as is or becomes practicable and/or desirable.

In some embodiments, the method 700 may comprise determining a pure premium, at 702. A pure premium is a basic, unadjusted premium that is generally calculated based on loss frequency and severity distributions. According to some embodiments, the flood risk and/or AFRS and/or non-AFRS loss frequency distributions (e.g., from 606a-b in FIG. 6) and the flood risk and/or AFRS and/or non-AFRS loss severity distributions (e.g., from 608a-b in FIG. 6) may be utilized to calculate a pure premium that would be expected, mathematically, to result in no net gain or loss for the insurer when considering only the actual cost of the loss or losses under consideration and their associated loss adjustment expenses. Determination of the pure premium may generally comprise simulation testing and analysis that predicts (e.g., based on the supplied frequency and severity distributions) expected total losses (flood risk and/or AFRS-based and/or non-AFRS-based) over time.

According to some embodiments, the method 700 may comprise determining an expense load, at 704. The pure premium determined at 702 does not take into account operational realities experienced by an insurer. The pure premium does not account, for example, for operational expenses such as overhead, staffing, taxes, fees, etc. Thus, in some embodiments, an expense load (or factor) is determined and utilized to take such costs into account when determining an appropriate premium to charge for an insurance product. According to some embodiments, the method 700 may comprise determining a risk load, at 706. The risk load is a factor designed to ensure that the insurer maintains a surplus amount large enough to produce an expected return for an insurance product.

According to some embodiments, the method 700 may comprise determining a total premium, at 708. The total premium may generally be determined and/or calculated by summing or totaling one or more of the pure premium, the expense load, and the risk load. In such a manner, for example, the pure premium is adjusted to compensate for real-world operating considerations that affect an insurer.

According to some embodiments, the method 700 may comprise grading the total premium, at 710. The total premium determined at 708, for example, may be ranked and/or scored by comparing the total premium to one or more benchmarks. In some embodiments, the comparison and/or grading may yield a qualitative measure of the total premium. The total premium may be graded, for example, on a scale of “A”, “B”, “C”, “D”, and “F”, in order of descending rank. The rating scheme may be simpler or more complex (e.g., similar to the qualitative bond and/or corporate credit rating schemes determined by various credit ratings agencies such as Standard & Poors' (S&P) Financial service LLC, Moody's Investment Service, and/or Fitch Ratings from Fitch, Inc., all of New York, N.Y.) of as is or becomes desirable and/or practicable. More details on one method for calculating and/or grading a premium are provided in commonly-assigned U.S. Pat. No. 7,330,820 entitled “PREMIUM EVALUATION SYSTEMS AND METHODS” which issued on Feb. 12, 2008, the premium calculation and grading concepts and descriptions of which are hereby incorporated by reference herein.

According to some embodiments, the method 700 may comprise outputting an evaluation, at 712. In the case that the results of the determination of the total premium at 708 are not directly and/or automatically utilized for implementation in association with an insurance product, for example, the grading of the premium at 710 and/or other data such as the risk score determined at 610 of FIG. 6 may be utilized to output an indication of the desirability and/or expected profitability of implementing the calculated premium. The outputting of the evaluation may be implemented in any form or manner that is or becomes known or practicable. One or more recommendations, graphical representations, visual aids, comparisons, and/or suggestions may be output, for example, to a device (e.g., a server and/or computer workstation) operated by an insurance underwriter and/or sales agent. One example of an evaluation comprises a creation and output of a risk matrix which may, for example, by developed utilizing Enterprise Risk Register® software which facilitates compliance with ISO 17799/ISO 27000 requirements for risk mitigation and which is available from Northwest Controlling Corporation Ltd. (NOWECO) of London, UK.

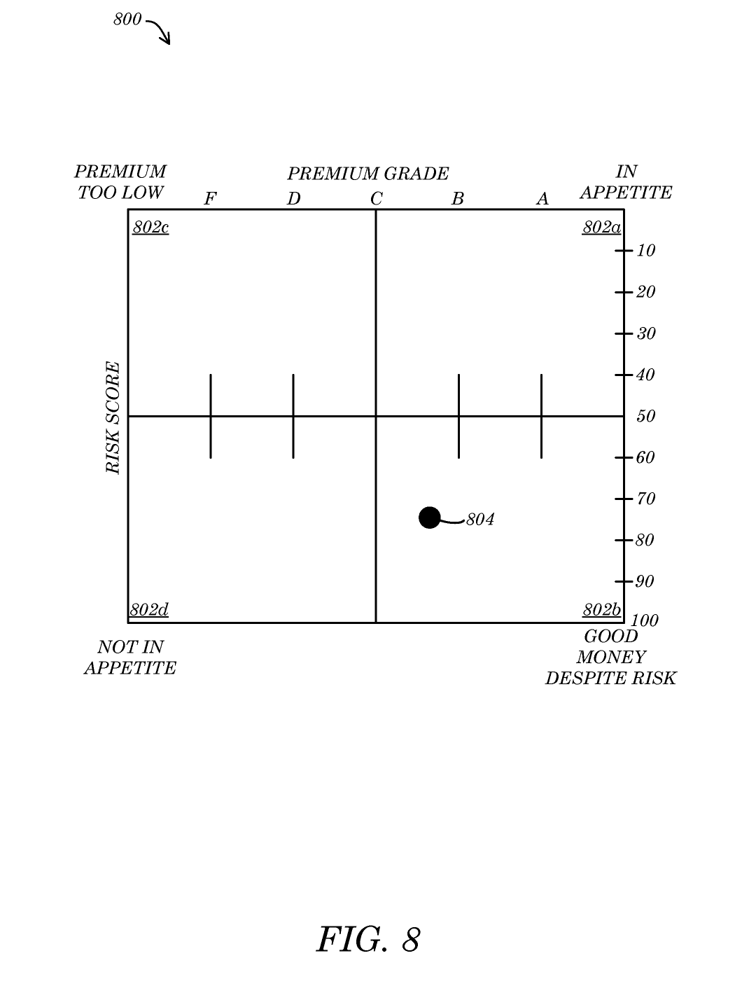

Referring to FIG. 8, for example, a diagram of an exemplary risk matrix 800 according to some embodiments is shown. In some embodiments (as depicted), the risk matrix 800 may comprise a simple two-dimensional graph having an X-axis and a Y-axis. Any other type of risk matrix, or no risk matrix, may be used if desired. The detail, complexity, and/or dimensionality of the risk matrix 800 may vary as desired and/or may be tied to a particular insurance product or offering. In some embodiments, the risk matrix 800 may be utilized to visually illustrate a relationship between the risk score (e.g., from 230 of FIG. 2 and/or from 610 of FIG. 6) of an object (and/or account and/or group of objects) and the total determined premium (e.g., from 240 of FIG. 2 and/or 708 of FIG. 7; and/or a grading thereof, such as from 710 of FIG. 7) for an insurance product offered in relation to the object (and/or account and/or group of objects). As shown in FIG. 8, for example, the premium grade may be plotted along the X-axis of the risk matrix 800 and/or the risk score may be plotted along the Y-axis of the risk matrix 800.

In such a manner, the risk matrix 800 may comprise four (4) quadrants 802a-d (e.g., similar to a “four-square” evaluation sheet utilized by automobile dealers to evaluate the propriety of various possible pricing “deals” for new automobiles). The first quadrant 802a represents the most desirable situations where risk scores are low and premiums are highly graded. The second quadrant 802b represents less desirable situations where, while premiums are highly graded, risk scores are higher. Generally, object-specific data that results in data points being plotted in either of the first two quadrants 802a-b is indicative of an object for which an insurance product may be offered on terms likely to be favorable to the insurer. The third quadrant 802c represents less desirable characteristics of having poorly graded premiums with low risk scores and the fourth quadrant 802d represents the least desirable characteristics of having poorly graded premiums as well as high risk scores. Generally, object-specific data that results in data points being plotted in either of the third and fourth quadrants 802c-d is indicative of an object for which an insurance product offering is not likely to be favorable to the insurer.

One example of how the risk matrix 800 may be output and/or implemented with respect to a flood risk and/or AFRS of an account and/or group of objects will now be described. Assume, for example, that a property insurance policy is desired by a consumer and/or that property insurance policy product is otherwise analyzed to determine whether such a policy would be beneficial for an insurer to issue. Typical risk metrics such as the flood zone in which the property is located, the size of the building, the age of the building/structure, and/or the construction type (e.g., brick, post and beam, reinforced concrete, and/or steel-frame) may be utilized to produce expected loss frequency and loss severity distributions (such as determined at 606b and 608b of FIG. 6).

In some embodiments, flood risk and/or AFRS metrics associated with the property and/or account (i.e., the object(s) being insured), such as a Total Insured Value (TIV) for the account and/or portfolio of properties, may also be utilized to produce expected flood risk and/or AFRS loss frequency and flood risk and/or AFRS loss severity distributions (such as determined at 606a and 608a of FIG. 6). According to some embodiments, singular loss frequency and loss severity distributions may be determined utilizing both typical risk metrics, as well as flood risk and/or AFRS metrics (of the object being insured and/or of other associated objects, such as other properties belonging to the same account, sub-account, etc.).

In the case that the AFRS for the account is greater than a certain pre-determined magnitude (e.g., threshold), based on total percent of TIV exposed for example, the risk score for the property and/or account may be determined to be relatively high, such as seventy-five (75) on a scale from zero (0) to one hundred (100), as compared to a score of fifty (50) for a second AFRS (e.g., a flood risk and/or building attribute and/or characteristic). Other non-AFRS factors such as the loss history for the account/object(s) (and/or other factors) may also contribute to the risk score for the property, building/structure, consumer, account, and/or insurance product associated therewith.

The total premium calculated for a potential insurance policy offering covering the property/account/object(s) (e.g., determined at 708 of FIG. 7) may, to continue the example, be graded between “B” and “C” (e.g., at 710 of FIG. 7) or between “Fair” and “Average”. The resulting combination of risk score and premium rating may be plotted on the risk matrix 800, as represented by a data point 804 shown in FIG. 8. The data point 804, based on the flood risk and/or AFRS-influenced risk score and the corresponding flood risk and/or AFRS-influenced premium calculation, is plotted in the second quadrant 802b, in a position indicating that while the risk of insuring the property/account/object(s) is relatively high, the calculated premium is probably large enough to compensate for the level of risk. In some embodiments, an insurer may accordingly look favorably upon issuing such as insurance policy to the client to cover the property/account/object(s) in question and/or may consummate a sale of such a policy to the consumer (e.g., based on the evaluation output at 712 of FIG. 7, such as decision and/or sale may be made).

Turning to FIG. 9A and FIG. 9B, example interfaces 920a-b according to some embodiments are shown. In some embodiments, the interfaces 920a-b may comprise a web page, web form, database entry form, Application Programming Interface (API), spreadsheet, table, and/or application or other Graphical User Interface (GUI) via which an underwriter (or customer or other entity) may enter data to conduct and/or facilitate an underwriting and/or sales process. The interfaces 920a-b may, for example, comprise a front-end of an underwriting program (and/or portion thereof) and/or platform programmed and/or otherwise configured to execute, conduct, and/or facilitate any of the various methods 200, 500, 600, 700 of FIG. 2, FIG. 5, FIG. 6, and/or FIG. 7 and/or portions and/or combinations thereof described herein. In some embodiments, the interfaces 920a-b may be output via a computerized device such as one or more of the user devices 102a-n and/or the controller device 110 of FIG. 1 herein. In some embodiments, the example interfaces 920a-b may comprise interface outputs of (and/or otherwise associated with) a GUI utilized to research, price, quote, purchase/sell, re-sell, and/or otherwise configure an underwriting product, such as may be implemented and/or provided as described herein.

A first example interface 920a as depicted in FIG. 9A, for example, may provide a plurality of available selection and/or fillable options for a structure details tab 922a. In some embodiments, the structure details tab 922a may comprise an account information section 924 and/or a structure information section 926. The account information section 924 may allow and/or provide for entry, input, and/or receipt and/or determination of account information, for example, and/or the structure information section 926 may allow and/or provide for entry, input, and/or receipt and/or determination of various structure, building, and/or object information. The account information section 924 may comprise, in accordance with some embodiments, an account name entry field 924-1 (e.g., that may relate to and/or cause a storing of information in the account ID field 444a-1 of the structure table 440a of FIG. 4A) and/or an account name search feature 924-2 (e.g., that allows a user to perform keyword and/or other searches for account-related information).

In some embodiments, the structure information section 926 may comprise a location ID entry field 926-1 (e.g., that may relate to and/or cause a storing of information in the location ID field 444a-3 of the structure table 440a of FIG. 4A), a number of stories drop-down menu 926-2 (e.g., that may relate to and/or cause a storing of information in the stories field 444a-4 of the structure table 440a of FIG. 4A), a basement radio-button 926-3 (e.g., that allows entry and/or provision/receipt of an indication of whether a particular object/structure has a basement), address information entry fields 926-4, a flood zone drop-down menu 926-5 (e.g., that may relate to and/or cause a storing of information in the flood zone field 444a-8 of the structure table 440a of FIG. 4A), a flood zone search feature 926-6 (e.g., that provides flood zone searching functionality, such as via one or more third-party data and/or service providers), a FRS entry field 926-7 (e.g., that may relate to and/or cause a storing of information in the FRS field 444a-9 of the structure table 440a of FIG. 4A), a flood risk probability field 926-8 (e.g., that may be populated based on data in the FRS entry field 926-7 and/or based on the FRS table 440c), and/or coverage value fields 926-9 (e.g., that may relate to and/or cause a storing of information in the structure value field 444a-5, the content value field 444a-6, and/or the business income value field 444a-7 of the structure table 440a of FIG. 4A). In some embodiments, the first example interface 920a may comprise one or more navigational and/or functional buttons 928 such as a “Save and Exit Account” feature 928-1 and/or a “Continue” feature 928-2.

In some embodiments, a second example interface 920b as depicted in FIG. 9B may also or alternatively provide a plurality of available selection and/or fillable options for an AFRS details tab 922b. In some embodiments, the AFRS details tab 922b may comprise the account information section 924 (and/or the account name entry field 924-1 and/or account name search feature 924-2 thereof) and/or an AFRS information section 930. The AFRS information section 930 may, for example, allow and/or provide for entry, input, calculation, and/or receipt and/or determination of AFRS data as described herein. The AFRS information section 930 may comprise, for example, flood zone sublimit fields 930-1, a full account TIV field 930-2, an FFV at-risk field 930-3, a percent TIV at-risk field 930-4, an AFRS field 930-5 (e.g., that may relate to and/or cause a storing of information in the AFRS field 444a-10 of the structure table 440a of FIG. 4A), an AFRS rating field 930-6 (e.g., that may be populated based on data in the AFRS field 930-5 and/or based on the AFRS table 440d), a TIV in Zone “V” field 930-7, and/or a contributors to AFRS listing 930-8.

According to some embodiments, the flood zone sublimit fields 930-1 (and/or data entered, received, and/or stored therein) may be utilized in addition to or in place of the coverage data utilized to determine adjusted FRS data, such as in formula (I) described in conjunction with 506 of the method 500 of FIG. 5 herein. In some embodiments, the flood zone sublimit fields 930-1 may be utilized to provide input such as in the case a customer and/or underwriter enters desired coverage limits for a prospective product. In some embodiments, the flood zone sublimit fields 930-1 may provide output and/or feedback regarding what coverage limits/levels are acceptable and/or desirable, e.g., based on other input information descriptive of policy and/or product parameters.

While the example interfaces 920a-b are depicted herein with respect to a specific example of an insurance product policy underwriting process, other products, risk assessments, searches, and/or other assessments may be provided in accordance with some embodiments. While the depicted risk assessment comprises an AFRS determination, for example, assessment of other underwriting metrics may also or alternatively be utilized by and/or incorporated into the interfaces 920a-b.

While various components of the interfaces 920a-b have been depicted with respect to certain labels, layouts, headings, titles, and/or configurations, these features have been presented for reference and example only. Other labels, layouts, headings, titles, and/or configurations may be implemented without deviating from the scope of embodiments herein. Similarly, while a certain number of tabs, information screens, form fields, and/or data entry options have been presented, variations thereof may be practiced in accordance with some embodiments.

Referring to FIG. 10, a block diagram of an apparatus 1010 according to some embodiments is shown. In some embodiments, the apparatus 1010 may be similar in configuration and/or functionality to any of the controller device 110, the user devices 102a-n, and/or the third-party device 106, all of FIG. 1 herein. The apparatus 1010 may, for example, execute, process, facilitate, and/or otherwise be associated with the methods 200, 500, 600, 700 of FIG. 2, FIG. 5, FIG. 6, and/or FIG. 7 herein. In some embodiments, the apparatus 1010 may comprise a processing device 1012, an input device 1014, an output device 1016, a communication device 1018, a memory device 1040, and/or a cooling device 1050. According to some embodiments, any or all of the components 1012, 1014, 1016, 1018, 1040, 1050 of the apparatus 1010 may be similar in configuration and/or functionality to any similarly named and/or numbered components described herein. Fewer or more components 1012, 1014, 1016, 1018, 1040, 1050 and/or various configurations of the components 1012, 1014, 1016, 1018, 1040, 1050 may be included in the apparatus 1010 without deviating from the scope of embodiments described herein.

According to some embodiments, the processor 1012 may be or include any type, quantity, and/or configuration of processor that is or becomes known. The processor 1012 may comprise, for example, an Intel® IXP 2800 network processor or an Intel® XEON™ Processor coupled with an Intel® E7501 chipset. In some embodiments, the processor 1012 may comprise multiple inter-connected processors, microprocessors, and/or micro-engines. According to some embodiments, the processor 1012 (and/or the apparatus 1010 and/or other components thereof) may be supplied power via a power supply (not shown) such as a battery, an Alternating Current (AC) source, a Direct Current (DC) source, an AC/DC adapter, solar cells, and/or an inertial generator. In the case that the apparatus 1010 comprises a server such as a blade server, necessary power may be supplied via a standard AC outlet, power strip, surge protector, and/or Uninterruptible Power Supply (UPS) device.

In some embodiments, the input device 1014 and/or the output device 1016 are communicatively coupled to the processor 1012 (e.g., via wired and/or wireless connections and/or pathways) and they may generally comprise any types or configurations of input and output components and/or devices that are or become known, respectively. The input device 1014 may comprise, for example, a keyboard that allows an operator of the apparatus 1010 to interface with the apparatus 1010 (e.g., by a consumer, such as to purchase insurance policies priced utilizing flood risk and/or AFRS metrics, and/or by an underwriter and/or insurance agent, such as to evaluate risk and/or calculate premiums for an insurance policy—e.g., based on an AFRS as described herein). In some embodiments, the input device 1014 may comprise a sensor configured to provide information such as encoded location, flood risk, and/or building information to the apparatus 1010 and/or the processor 1012. The output device 1016 may, according to some embodiments, comprise a display screen and/or other practicable output component and/or device. The output device 1016 may, for example, provide insurance and/or investment pricing and/or risk analysis to a potential client (e.g., via a website) and/or to an underwriter or sales agent attempting to structure an insurance (and/or investment) product (e.g., via a computer workstation). According to some embodiments, the input device 1014 and/or the output device 1016 may comprise and/or be embodied in a single device such as a touch-screen monitor.

In some embodiments, the communication device 1018 may comprise any type or configuration of communication device that is or becomes known or practicable. The communication device 1018 may, for example, comprise a Network Interface Card (NIC), a telephonic device, a cellular network device, a router, a hub, a modem, and/or a communications port or cable. In some embodiments, the communication device 1018 may be coupled to provide data to a client device, such as in the case that the apparatus 1010 is utilized to price and/or sell underwriting products (e.g., based at least in part on AFRS data). The communication device 1018 may, for example, comprise a cellular telephone network transmission device that sends signals indicative of flood risk and/or AFRS metrics to a handheld, mobile, and/or telephone device. According to some embodiments, the communication device 1018 may also or alternatively be coupled to the processor 1012. In some embodiments, the communication device 1018 may comprise an IR, RF, Bluetooth™, Near-Field Communication (NFC), and/or Wi-Fi® network device coupled to facilitate communications between the processor 1012 and another device (such as a client device and/or a third-party device, not shown in FIG. 10).

The memory device 1040 may comprise any appropriate information storage device that is or becomes known or available, including, but not limited to, units and/or combinations of magnetic storage devices (e.g., a hard disk drive), optical storage devices, and/or semiconductor memory devices such as RAM devices, Read Only Memory (ROM) devices, Single Data Rate Random Access Memory (SDR-RAM), Double Data Rate Random Access Memory (DDR-RAM), and/or Programmable Read Only Memory (PROM). The memory device 1040 may, according to some embodiments, store one or more of AFRS instructions 1042-1, risk assessment instructions 1042-2, underwriting instructions 1042-3, premium determination instructions 1042-4, client data 1044-1, building data 1044-2, flood risk data 1044-3, underwriting data 1044-4, and/or claim/loss data 1044-5. In some embodiments, the AFRS instructions 1042-1, risk assessment instructions 1042-2, underwriting instructions 1042-3, and/or premium determination instructions 1042-4 may be utilized by the processor 1012 to provide output information via the output device 1016 and/or the communication device 1018.

According to some embodiments, the AFRS instructions 1042-1 may be operable to cause the processor 1012 to process the client data 1044-1, building data 1044-2, flood risk data 1044-3, underwriting data 1044-4, and/or claim/loss data 1044-5 in accordance with embodiments as described herein. Client data 1044-1, building data 1044-2, flood risk data 1044-3, underwriting data 1044-4, and/or claim/loss data 1044-5 received via the input device 1014 and/or the communication device 1018 may, for example, be analyzed, sorted, filtered, decoded, decompressed, ranked, scored, plotted, and/or otherwise processed by the processor 1012 in accordance with the AFRS instructions 1042-1. In some embodiments, client data 1044-1, building data 1044-2, flood risk data 1044-3, underwriting data 1044-4, and/or claim/loss data 1044-5 may be fed by the processor 1012 through one or more mathematical and/or statistical formulas and/or models in accordance with the AFRS instructions 1042-1 to define one or more flood risk and/or AFRS metrics, indices, and/or models that may then be utilized to inform and/or affect insurance and/or other underwriting product determinations and/or sales as described herein.

In some embodiments, the risk assessment instructions 1042-2 may be operable to cause the processor 1012 to process the client data 1044-1, building data 1044-2, flood risk data 1044-3, underwriting data 1044-4, and/or claim/loss data 1044-5 in accordance with embodiments as described herein. Client data 1044-1, building data 1044-2, flood risk data 1044-3, underwriting data 1044-4, and/or claim/loss data 1044-5 received via the input device 1014 and/or the communication device 1018 may, for example, be analyzed, sorted, filtered, decoded, decompressed, ranked, scored, plotted, and/or otherwise processed by the processor 1012 in accordance with the risk assessment instructions 1042-2. In some embodiments, client data 1044-1, building data 1044-2, flood risk data 1044-3, underwriting data 1044-4, and/or claim/loss data 1044-5 may be fed by the processor 1012 through one or more mathematical and/or statistical formulas and/or models in accordance with the risk assessment instructions 1042-2 to inform and/or affect risk assessment processes and/or decisions in relation to surface segment characteristics, as described herein.

According to some embodiments, the underwriting instructions 1042-3 may be operable to cause the processor 1012 to process the client data 1044-1, building data 1044-2, flood risk data 1044-3, underwriting data 1044-4, and/or claim/loss data 1044-5 in accordance with embodiments as described herein. Client data 1044-1, building data 1044-2, flood risk data 1044-3, underwriting data 1044-4, and/or claim/loss data 1044-5 received via the input device 1014 and/or the communication device 1018 may, for example, be analyzed, sorted, filtered, decoded, decompressed, ranked, scored, plotted, and/or otherwise processed by the processor 1012 in accordance with the underwriting instructions 1042-3. In some embodiments, client data 1044-1, building data 1044-2, flood risk data 1044-3, underwriting data 1044-4, and/or claim/loss data 1044-5 may be fed by the processor 1012 through one or more mathematical and/or statistical formulas and/or models in accordance with the underwriting instructions 1042-3 to cause, facilitate, inform, and/or affect underwriting product determinations and/or sales (e.g., based at least in part on AFRS data) as described herein.

In some embodiments, the premium determination instructions 1042-4 may be operable to cause the processor 1012 to process the client data 1044-1, building data 1044-2, flood risk data 1044-3, underwriting data 1044-4, and/or claim/loss data 1044-5 in accordance with embodiments as described herein. Client data 1044-1, building data 1044-2, flood risk data 1044-3, underwriting data 1044-4, and/or claim/loss data 1044-5 received via the input device 1014 and/or the communication device 1018 may, for example, be analyzed, sorted, filtered, decoded, decompressed, ranked, scored, plotted, and/or otherwise processed by the processor 1012 in accordance with the premium determination instructions 1042-4. In some embodiments, client data 1044-1, building data 1044-2, flood risk data 1044-3, underwriting data 1044-4, and/or claim/loss data 1044-5 may be fed by the processor 1012 through one or more mathematical and/or statistical formulas and/or models in accordance with the premium determination instructions 1042-4 to cause, facilitate, inform, and/or affect underwriting product premium determinations and/or sales (e.g., based at least in part on AFRS data) as described herein.

In some embodiments, the apparatus 1010 may function as a computer terminal and/or server of an insurance and/or underwriting company, for example, that is utilized to process insurance applications. In some embodiments, the apparatus 1010 may comprise a web server and/or other portal (e.g., an Interactive Voice Response Unit (IVRU)) that provides AFRS-based underwriting product determinations and/or products to clients.

In some embodiments, the apparatus 1010 may comprise the cooling device 1050. According to some embodiments, the cooling device 1050 may be coupled (physically, thermally, and/or electrically) to the processor 1012 and/or to the memory device 1040. The cooling device 1050 may, for example, comprise a fan, heat sink, heat pipe, radiator, cold plate, and/or other cooling component or device or combinations thereof, configured to remove heat from portions or components of the apparatus 1010.

Any or all of the exemplary instructions and data types described herein and other practicable types of data may be stored in any number, type, and/or configuration of memory devices that is or becomes known. The memory device 1040 may, for example, comprise one or more data tables or files, databases, table spaces, registers, and/or other storage structures. In some embodiments, multiple databases and/or storage structures (and/or multiple memory devices 1040) may be utilized to store information associated with the apparatus 1010. According to some embodiments, the memory device 1040 may be incorporated into and/or otherwise coupled to the apparatus 1010 (e.g., as shown) or may simply be accessible to the apparatus 1010 (e.g., externally located and/or situated).

Referring to FIG. 11A, FIG. 11B, FIG. 11C, and FIG. 11D, perspective diagrams of exemplary data storage devices 1140a-d according to some embodiments are shown. The data storage devices 1140a-d may, for example, be utilized to store instructions and/or data such as the AFRS instructions 1042-1, risk assessment instructions 1042-2, underwriting instructions 1042-3, premium determination instructions 1042-4, client data 1044-1, building data 1044-2, flood risk data 1044-3, underwriting data 1044-4, and/or claim/loss data 1044-5, each of which is described in reference to FIG. 10 herein. In some embodiments, instructions stored on the data storage devices 1140a-d may, when executed by a processor, cause the implementation of and/or facilitate the methods 200, 500, 600, 700 of FIG. 2, FIG. 5, FIG. 6, and/or FIG. 7 herein (or any portions or combinations thereof).

According to some embodiments, the first data storage device 1140a may comprise a CD, CD-ROM, DVD, Blu-Ray™ Disc, and/or other type of optically-encoded disk and/or other storage medium that is or becomes know or practicable. In some embodiments, the second data storage device 1140b may comprise a USB keyfob, dongle, and/or other type of flash memory data storage device that is or becomes know or practicable. In some embodiments, the third data storage device 1140c may comprise RAM of any type, quantity, and/or configuration that is or becomes practicable and/or desirable. In some embodiments, the third data storage device 1140c may comprise an off-chip cache such as a Level 2 (L2) cache memory device. According to some embodiments, the fourth data storage device 1140d may comprise an on-chip memory device such as a Level 1 (L1) cache memory device.

The data storage devices 1140a-d may generally store program instructions, code, and/or modules that, when executed by a processing device cause a particular machine to function in accordance with one or more embodiments described herein. The data storage devices 1140a-d depicted in FIG. 11A, FIG. 11B, FIG. 11C, and FIG. 11D are representative of a class and/or subset of computer-readable media that are defined herein as “computer-readable memory” (e.g., non-transitory memory devices as opposed to transmission devices or media).

Some embodiments described herein are associated with a “user device” or a “network device”. As used herein, the terms “user device” and “network device” may be used interchangeably and may generally refer to any device that can communicate via a network. Examples of user or network devices include a PC, a workstation, a server, a printer, a scanner, a facsimile machine, a copier, a Personal Digital Assistant (PDA), a storage device (e.g., a disk drive), a hub, a router, a switch, and a modem, a video game console, or a wireless phone. User and network devices may comprise one or more communication or network components. As used herein, a “user” may generally refer to any individual and/or entity that operates a user device. Users may comprise, for example, customers, consumers, product underwriters, product distributors, customer service representatives, agents, brokers, etc.

As used herein, the term “network component” may refer to a user or network device, or a component, piece, portion, or combination of user or network devices. Examples of network components may include a Static Random Access Memory (SRAM) device or module, a network processor, and a network communication path, connection, port, or cable.

In addition, some embodiments are associated with a “network” or a “communication network”. As used herein, the terms “network” and “communication network” may be used interchangeably and may refer to any object, entity, component, device, and/or any combination thereof that permits, facilitates, and/or otherwise contributes to or is associated with the transmission of messages, packets, signals, and/or other forms of information between and/or within one or more network devices. Networks may be or include a plurality of interconnected network devices. In some embodiments, networks may be hard-wired, wireless, virtual, neural, and/or any other configuration of type that is or becomes known. Communication networks may include, for example, one or more networks configured to operate in accordance with the Fast Ethernet LAN transmission standard 802.3-2002® published by the Institute of Electrical and Electronics Engineers (IEEE). In some embodiments, a network may include one or more wired and/or wireless networks operated in accordance with any communication standard or protocol that is or becomes known or practicable.

As used herein, the terms “information” and “data” may be used interchangeably and may refer to any data, text, voice, video, image, message, bit, packet, pulse, tone, waveform, and/or other type or configuration of signal and/or information. Information may comprise information packets transmitted, for example, in accordance with the Internet Protocol Version 6 (IPv6) standard as defined by “Internet Protocol Version 6 (IPv6) Specification” RFC 1883, published by the Internet Engineering Task Force (IETF), Network Working Group, S. Deering et al. (December 1995). Information may, according to some embodiments, be compressed, encoded, encrypted, and/or otherwise packaged or manipulated in accordance with any method that is or becomes known or practicable.

In addition, some embodiments described herein are associated with an “indication”. As used herein, the term “indication” may be used to refer to any indicia and/or other information indicative of or associated with a subject, item, entity, and/or other object and/or idea. As used herein, the phrases “information indicative of” and “indicia” may be used to refer to any information that represents, describes, and/or is otherwise associated with a related entity, subject, or object. Indicia of information may include, for example, a code, a reference, a link, a signal, an identifier, and/or any combination thereof and/or any other informative representation associated with the information. In some embodiments, indicia of information (or indicative of the information) may be or include the information itself and/or any portion or component of the information. In some embodiments, an indication may include a request, a solicitation, a broadcast, and/or any other form of information gathering and/or dissemination.

Numerous embodiments are described in this patent application, and are presented for illustrative purposes only. The described embodiments are not, and are not intended to be, limiting in any sense. The presently disclosed invention(s) are widely applicable to numerous embodiments, as is readily apparent from the disclosure. One of ordinary skill in the art will recognize that the disclosed invention(s) may be practiced with various modifications and alterations, such as structural, logical, software, and electrical modifications. Although particular features of the disclosed invention(s) may be described with reference to one or more particular embodiments and/or drawings, it should be understood that such features are not limited to usage in the one or more particular embodiments or drawings with reference to which they are described, unless expressly specified otherwise.

Devices that are in communication with each other need not be in continuous communication with each other, unless expressly specified otherwise. On the contrary, such devices need only transmit to each other as necessary or desirable, and may actually refrain from exchanging data most of the time. For example, a machine in communication with another machine via the Internet may not transmit data to the other machine for weeks at a time. In addition, devices that are in communication with each other may communicate directly or indirectly through one or more intermediaries.

A description of an embodiment with several components or features does not imply that all or even any of such components and/or features are required. On the contrary, a variety of optional components are described to illustrate the wide variety of possible embodiments of the present invention(s). Unless otherwise specified explicitly, no component and/or feature is essential or required.

Further, although process steps, algorithms or the like may be described in a sequential order, such processes may be configured to work in different orders. In other words, any sequence or order of steps that may be explicitly described does not necessarily indicate a requirement that the steps be performed in that order. The steps of processes described herein may be performed in any order practical. Further, some steps may be performed simultaneously despite being described or implied as occurring non-simultaneously (e.g., because one step is described after the other step). Moreover, the illustration of a process by its depiction in a drawing does not imply that the illustrated process is exclusive of other variations and modifications thereto, does not imply that the illustrated process or any of its steps are necessary to the invention, and does not imply that the illustrated process is preferred.

“Determining” something can be performed in a variety of manners and therefore the term “determining” (and like terms) includes calculating, computing, deriving, looking up (e.g., in a table, database or data structure), ascertaining and the like.

It will be readily apparent that the various methods and algorithms described herein may be implemented by, e.g., appropriately and/or specially-programmed general purpose computers and/or computing devices. Typically a processor (e.g., one or more microprocessors) will receive instructions from a memory or like device, and execute those instructions, thereby performing one or more processes defined by those instructions. Further, programs that implement such methods and algorithms may be stored and transmitted using a variety of media (e.g., computer readable media) in a number of manners. In some embodiments, hard-wired circuitry or custom hardware may be used in place of, or in combination with, software instructions for implementation of the processes of various embodiments. Thus, embodiments are not limited to any specific combination of hardware and software

A “processor” generally means any one or more microprocessors, CPU devices, computing devices, microcontrollers, digital signal processors, or like devices, as further described herein.

The term “computer-readable medium” refers to any medium that participates in providing data (e.g., instructions or other information) that may be read by a computer, a processor or a like device. Such a medium may take many forms, including but not limited to, non-volatile media, volatile media, and transmission media. Non-volatile media include, for example, optical or magnetic disks and other persistent memory. Volatile media include DRAM, which typically constitutes the main memory. Transmission media include coaxial cables, copper wire and fiber optics, including the wires that comprise a system bus coupled to the processor. Transmission media may include or convey acoustic waves, light waves and electromagnetic emissions, such as those generated during RF and IR data communications. Common forms of computer-readable media include, for example, a floppy disk, a flexible disk, hard disk, magnetic tape, any other magnetic medium, a CD-ROM, DVD, any other optical medium, punch cards, paper tape, any other physical medium with patterns of holes, a RAM, a PROM, an EPROM, a FLASH-EEPROM, any other memory chip or cartridge, a carrier wave, or any other medium from which a computer can read.

The term “computer-readable memory” may generally refer to a subset and/or class of computer-readable medium that does not include transmission media such as waveforms, carrier waves, electromagnetic emissions, etc. Computer-readable memory may typically include physical media upon which data (e.g., instructions or other information) are stored, such as optical or magnetic disks and other persistent memory, DRAM, a floppy disk, a flexible disk, hard disk, magnetic tape, any other magnetic medium, a CD-ROM, DVD, any other optical medium, punch cards, paper tape, any other physical medium with patterns of holes, a RAM, a PROM, an EPROM, a FLASH-EEPROM, any other memory chip or cartridge, computer hard drives, backup tapes, Universal Serial Bus (USB) memory devices, and the like.

Various forms of computer readable media may be involved in carrying data, including sequences of instructions, to a processor. For example, sequences of instruction (i) may be delivered from RAM to a processor, (ii) may be carried over a wireless transmission medium, and/or (iii) may be formatted according to numerous formats, standards or protocols, such as Bluetooth™, TDMA, CDMA, 3G.

Where databases are described, it will be understood by one of ordinary skill in the art that (i) alternative database structures to those described may be readily employed, and (ii) other memory structures besides databases may be readily employed. Any illustrations or descriptions of any sample databases presented herein are illustrative arrangements for stored representations of information. Any number of other arrangements may be employed besides those suggested by, e.g., tables illustrated in drawings or elsewhere. Similarly, any illustrated entries of the databases represent exemplary information only; one of ordinary skill in the art will understand that the number and content of the entries can be different from those described herein. Further, despite any depiction of the databases as tables, other formats (including relational databases, object-based models and/or distributed databases) could be used to store and manipulate the data types described herein. Likewise, object methods or behaviors of a database can be used to implement various processes, such as the described herein. In addition, the databases may, in a known manner, be stored locally or remotely from a device that accesses data in such a database.

The present invention can be configured to work in a network environment including a computer that is in communication, via a communications network, with one or more devices. The computer may communicate with the devices directly or indirectly, via a wired or wireless medium such as the Internet, LAN, WAN or Ethernet, Token Ring, or via any appropriate communications means or combination of communications means. Each of the devices may comprise computers, such as those based on the Intel® Pentium® or Centrino™ processor, that are adapted to communicate with the computer. Any number and type of machines may be in communication with the computer.

The present disclosure provides, to one of ordinary skill in the art, an enabling description of several embodiments and/or inventions. Some of these embodiments and/or inventions may not be claimed in the present application, but may nevertheless be claimed in one or more continuing applications that claim the benefit of priority of the present application. Applicants intend to file additional applications to pursue patents for subject matter that has been disclosed and enabled but not claimed in the present application.

What is claimed is:

1. A method, comprising:
determining, by a processing device, an account for which a flood risk assessment is desired;
determining, by the processing device, a first structure and a second structure associated with the account;
determining, by the processing device and for each of the first and second structures, (i) a total insurance coverage amount, (ii) a first-floor value amount, and (iii) a flood risk score;
determining, by the processing device and based on the (i) total insurance coverage amount, (ii) first-floor value amount, and (iii) flood risk score for each of the first and second structures, an account flood risk score; and
providing, by the processing device and based on the account flood risk score, an indication of an insurance determination.

2. The method of claim 1, wherein the providing comprises:
outputting an indication of the insurance determination.

3. The method of claim 1, wherein the insurance determination comprises a qualitative measure of overall account flood risk.

4. The method of claim 1, wherein the insurance determination comprises an indication descriptive of whether or not an insurance product should be offered for at least one of (i) the account, (ii) the first structure, and (iii) the second structure.

5. The method of claim 1, wherein the determining of the first structure and the second structure associated with the account is based on a stored association between each of the first and second structures and a unique certified location identifier.

6. The method of claim 1, wherein the determining of the first-floor value amount for each of the first and second structures comprises:
(1) determining (i) a building coverage portion of the total insurance coverage amount, (ii) a contents coverage portion of the total insurance coverage amount, and (iii) a business interruption coverage portion of the total insurance coverage amount;
(2) dividing the sum of (a) the building coverage portion and the contents coverage portion by (b) a number of stories of the respective structure;
(3) dividing the business interruption coverage portion by the number of stories of the respective structure;
(4) multiplying the quotient from (3) by a flood risk factor; and
(5) summing the quotient from (2) and the product from (4).

7. The method of claim 1, wherein the determining of the account flood risk score comprises:
(1) multiplying the first-floor value amount of the first structure by a probability associated with the flood risk score of the first structure;
(2) multiplying the first-floor value amount of the second structure by a probability associated with the flood risk score of the second structure;
(3) summing the products of (1) and (2);
(4) summing the first-floor value amounts for the first and second structures; and
(5) dividing the sum from (3) by the sum from (4).

8. The method of claim 7, wherein the determining of the account flood risk score further comprises:
determining, based on the quotient from (5), an account flood risk score stored in a database.

9. The method of claim 1, wherein the providing comprises:
providing a graphical user interface that outputs the indication of the insurance determination.

10. The method of claim 1, further comprising:
providing an indication of which of the first and second structures contributes most to the magnitude of the account flood risk score.

11. A system, comprising:
a processing device; and
a memory device in communication with the processing device, the memory device storing instructions that when executed by the processing device result in:
determining an account for which a flood risk assessment is desired;
determining a first structure and a second structure associated with the account;
determining, for each of the first and second structures, (i) a total insurance coverage amount, (ii) a first-floor value amount, and (iii) a flood risk score;
determining, based on the (i) total insurance coverage amount, (ii) first-floor value amount, and (iii) flood risk score for each of the first and second structures, an account flood risk score; and
providing, based on the account flood risk score, an indication of an insurance determination.

12. The system of claim 11, wherein the providing comprises:
outputting an indication of the insurance determination.

13. The system of claim 11, wherein the insurance determination comprises a qualitative measure of overall account flood risk.

14. The system of claim 11, wherein the insurance determination comprises an indication descriptive of whether or not an insurance product should be offered for at least one of (i) the account, (ii) the first structure, and (iii) the second structure.

15. The system of claim 11, wherein the determining of the first structure and the second structure associated with the account is based on a stored association between each of the first and second structures and a unique certified location identifier.

16. The system of claim 11, wherein the determining of the first-floor value amount for each of the first and second structures comprises:
(1) determining (i) a building coverage portion of the total insurance coverage amount, (ii) a contents coverage portion of the total insurance coverage amount, and (iii) a business interruption coverage portion of the total insurance coverage amount;
(2) dividing the sum of (a) the building coverage portion and the contents coverage portion by (b) a number of stories of the respective structure;
(3) dividing the business interruption coverage portion by the number of stories of the respective structure;
(4) multiplying the quotient from (3) by a flood risk factor; and
(5) summing the quotient from (2) and the product from (4).

17. The system of claim 11, wherein the determining of the account flood risk score comprises:
(1) multiplying the first-floor value amount of the first structure by a probability associated with the flood risk score of the first structure;
(2) multiplying the first-floor value amount of the second structure by a probability associated with the flood risk score of the second structure;
(3) summing the products of (1) and (2);
(4) summing the first-floor value amounts for the first and second structures; and
(5) dividing the sum from (3) by the sum from (4).

18. The system of claim 17, wherein the determining of the account flood risk score further comprises:
determining, based on the quotient from (5), an account flood risk score stored in a database.

19. The system of claim 11, wherein the providing comprises:
providing a graphical user interface that outputs the indication of the insurance determination.

20. The system of claim 11, wherein the instructions, when executed by the processing device, further result in:
providing an indication of which of the first and second structures contributes most to the magnitude of the account flood risk score.

21. A computer-readable memory storing instructions that when executed by a processing device result in:
determining an account for which a flood risk assessment is desired;
determining a first structure and a second structure associated with the account;
determining, for each of the first and second structures, (i) a total insurance coverage amount, (ii) a first-floor value amount, and (iii) a flood risk score;
determining, based on the (i) total insurance coverage amount, (ii) first-floor value amount, and (iii) flood risk score for each of the first and second structures, an account flood risk score; and
providing, based on the account flood risk score, an indication of an insurance determination.

22. The computer-readable memory of claim 21, wherein the providing comprises:
outputting an indication of the insurance determination.

23. The computer-readable memory of claim 21, wherein the insurance determination comprises a qualitative measure of overall account flood risk.

24. The computer-readable memory of claim 21, wherein the insurance determination comprises an indication descriptive of whether or not an insurance product should be offered for at least one of (i) the account, (ii) the first structure, and (iii) the second structure.

25. The system of claim 21, wherein the determining of the first structure and the second structure associated with the account is based on a stored association between each of the first and second structures and a unique certified location identifier.

26. The computer-readable memory of claim 21, wherein the determining of the first-floor value amount for each of the first and second structures comprises:
(1) determining (i) a building coverage portion of the total insurance coverage amount, (ii) a contents coverage portion of the total insurance coverage amount, and (iii) a business interruption coverage portion of the total insurance coverage amount;
(2) dividing the sum of (a) the building coverage portion and the contents coverage portion by (b) a number of stories of the respective structure;
(3) dividing the business interruption coverage portion by the number of stories of the respective structure;
(4) multiplying the quotient from (3) by a flood risk factor; and
(5) summing the quotient from (2) and the product from (4).

27. The computer-readable memory of claim 21, wherein the determining of the account flood risk score comprises:
(1) multiplying the first-floor value amount of the first structure by a probability associated with the flood risk score of the first structure;
(2) multiplying the first-floor value amount of the second structure by a probability associated with the flood risk score of the second structure;
(3) summing the products of (1) and (2);
(4) summing the first-floor value amounts for the first and second structures; and
(5) dividing the sum from (3) by the sum from (4).

28. The computer-readable memory of claim 27, wherein the determining of the account flood risk score further comprises:
determining, based on the quotient from (5), an account flood risk score stored in a database.

29. The computer-readable memory of claim 21, wherein the providing comprises:
providing a graphical user interface that outputs the indication of the insurance determination.

30. The computer-readable memory of claim 21, wherein the instructions, when executed by the processing device, further result in:
providing an indication of which of the first and second structures contributes most to the magnitude of the account flood risk score.
